(19) United States
(12) Patent Application Publication
(10) Pub. No.: US 2025/0100450 A1
(43) Pub. Date: Mar. 27, 2025

(54) VIDEO DISPLAY SYSTEM AND WORK VEHICLE

(71) Applicant: Kubota Corporation, Osaka (JP)

(72) Inventors: Takafumi FUJII, Sakai-shi (JP); Yushi MATSUZAKI, Sakai-shi (JP); Yoshiki TOKIEDA, Sakai-shi (JP)

(21) Appl. No.: 18/973,396

(22) Filed: Dec. 9, 2024

Related U.S. Application Data
(63) Continuation of application No. PCT/JP2023/019734, filed on May 26, 2023.

(30) Foreign Application Priority Data
Jun. 16, 2022 (JP) 2022-097599
Jun. 16, 2022 (JP) 2022-097600

(51) Int. Cl. B60R 1/24; A01B 69/04; G01C 21/00; H04N 7/18

(52) U.S. Cl. CPC B60R 1/24; G01C 21/3807; G01C 21/3837; A01B 69/008; B60R 2300/205; B60R 2300/301; B60R 2300/8086; B60R 2300/8093; H04N 7/183

(57) ABSTRACT

A video display system includes a camera attached to a work vehicle to which an implement is connected, and configured to generate data of time-series images by performing imaging in a travel direction of the work vehicle, a screen, and a controller configured or programmed to display, on the screen, a video based on the data of the time-series images. The controller is configured or programmed to, when the implement is connected to the work vehicle on the opposite side of the work vehicle from the travel direction, display on the screen, a superimposed video in which a path for the implement is superimposed on the video.

### CROSS REFERENCE TO RELATED APPLICATIONS

This application claims the benefit of priority to Japanese Patent Application Nos. 2022-097599 and 2022-097600 filed on Jun. 16, 2022 and is a Continuation Application of PCT Application No. PCT/JP2023/019734 filed on May 26, 2023. The entire contents of each application are hereby incorporated herein by reference.

### BACKGROUND OF THE INVENTION

### 1. Field of the Invention

The present disclosure relates to video display systems and work vehicles.

### 2. Description of the Related Art

Research and development has been directed to the automation of agricultural machines that are used in agricultural fields. For example, work vehicles such as tractors, combines, and rice transplanters which automatically travel within fields by utilizing a positioning system, e.g., a global navigation satellite system (GNSS), have been put into practical use. Research and development are also underway for work vehicles that automatically travel inside as well as outside fields. Technologies for remotely operating agricultural machines have also been being developed.

Japanese Laid-Open Patent Publication No. 2021-073602 and Japanese Laid-Open Patent Publication No. 2021-029218 each disclose an example of a system that allows an unmanned work vehicle to automatically travel between two fields separated from each other with a road interposed therebetween. International Publication WO2016/017367 discloses an example of a device that remotely operates a work vehicle that travels autonomously.

### SUMMARY OF THE INVENTION

The present disclosure provides techniques for displaying, on a screen, a superimposed video in which an image showing at least one of a path for an implement and a work trace after ground work of the implement, in the travel direction of a work vehicle, is superimposed on a video.

A video display system according to an example embodiment of the present disclosure includes a camera attached to a work vehicle to which an implement is connected and configured to generate data of time-series images by performing imaging in a travel direction of the work vehicle, a screen, and a controller configured or programmed to display, on the screen, a video based on the data of the time-series images. The controller is configured or programmed to, when the implement is connected to the work vehicle on the opposite side of the work vehicle from the travel direction, display, on the screen, a superimposed video in which a path for the implement is superimposed on the video.

An agricultural machine according to an example embodiment of the present disclosure includes a work vehicle, an implement, and the above video display system.

A video display system according to another example embodiment of the present disclosure includes a camera attached to a work vehicle to which an implement is connected and configured to generate data of time-series images by performing imaging in a travel direction of the work vehicle, a screen, and a controller configured or programmed to display, on the screen, a video based on the data of the time-series images. The controller is configured or programmed to display, on the screen, a superimposed video in which an image showing a work trace after ground work in the travel direction predicted when the work vehicle with the implement connected thereto is traveling is superimposed on the video.

An agricultural machine according to another example embodiment of the present disclosure includes a work vehicle, an implement, and the above video display system.

Example embodiments of the present disclosure may be implemented using devices, systems, methods, integrated circuits, computer programs, non-transitory computer-readable storage media, or any combination thereof. The computer-readable storage media may include volatile and non-volatile storage media. The devices each may include a plurality of devices. In the case in which each of the devices includes two or more devices, the two or more devices may be provided in a single apparatus, or separately provided in two or more different apparatuses.

According to the example embodiments of the present disclosure, a superimposed video in which an image showing at least one of a path for an implement and a work trace after ground work of the implement, in the travel direction of a work vehicle, is superimposed on a video, can be displayed on a screen.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a diagram illustrating an example configuration of an agricultural management system.

FIG. 1B is a diagram illustrating another example configuration of an agricultural management system.

FIG. 2 is a side view schematically illustrating an example of a work vehicle and an example of an implement that is connected to the work vehicle.

FIG. 3 is a block diagram illustrating an example configuration of a work vehicle and an implement.

FIG. 4 is a conceptual diagram illustrating an example of a work vehicle that performs positioning based on RTK-GNSS.

FIG. 5 is a diagram illustrating an example of an operation terminal and an example of operation switches disposed in a cabin.

FIG. 6 is a block diagram illustrating hardware configurations of a management device and a remote device.

FIG. 7 is a diagram schematically illustrating an example of a work vehicle that automatically travels along a target path in a field.

FIG. 8 is a flowchart illustrating an example operation of steering control during automated driving.

FIG. 9A is a diagram illustrating an example of a work vehicle that travels along a target path P.

FIG. 9B is a diagram illustrating an example of a work vehicle that is located at a position away from and to the right of a target path P.

FIG. 9C is a diagram illustrating an example of a work vehicle that is located at a position away from and to the left of a target path P.

FIG. 9D is a diagram illustrating an example of a work vehicle that faces in a direction tilted with respect to a target path P.

FIG. 10 is a diagram schematically illustrating an example of a situation in which a plurality of work vehicles are automatically traveling in a field and on a road outside fields.

FIG. 11 is a diagram illustrating an example of a display screen in an automatic traveling mode.

FIG. 12A is a diagram schematically illustrating an example of a video showing an area in front of a work vehicle, which is displayed on a screen.

FIG. 12B is a diagram schematically illustrating an example of a superimposed video in which a path for an implement in the travel direction of a work vehicle is superimposed on a video.

FIG. 13 is a diagram schematically illustrating a positional relationship between a reference point in a local coordinate system of a work vehicle and the positions of both end portions of an implement.

FIG. 14 is a diagram schematically illustrating an example of a superimposed video in which paths for an implement and paths for a pair of rear wheels are superimposed on a video.

FIG. 15 is a diagram schematically illustrating an example of a superimposed video in which paths for an implement and a target line along a target path are superimposed on a video.

FIG. 16 is a schematic diagram for describing the amount of a deviation of predicted paths for an implement from reference paths.

FIG. 17 is a diagram schematically illustrating an example of a superimposed video including a warning indication that is displayed on a screen when a deviation amount is not less than a threshold.

FIG. 18 is a diagram schematically illustrating a positional relationship between a reference point in a local coordinate system of a work vehicle, and the position of one side portion of an implement installed off-center.

FIG. 19 is a diagram schematically illustrating an example of a superimposed video in which a path for an off-center implement is superimposed on a video.

FIG. 20 is a diagram schematically illustrating an example of a video showing that there is a footbridge grade-separated from a road outside fields in the travel direction of a work vehicle traveling on the road.

FIG. 21 is a schematic diagram illustrating an example configuration of a HUD unit.

FIG. 22 is a diagram schematically illustrating an example of a superimposed video in which a work trace after ground work in the travel direction is superimposed on a video.

FIG. 23 is a diagram schematically illustrating another example of a superimposed video in which a work trace after ground work in the travel direction is superimposed on a video.

FIG. 24 is a diagram schematically illustrating a superimposed video in which a work trace after ground work and a target line are superimposed on a video.

FIG. 25 is a diagram schematically illustrating an example of a superimposed video including a guidance indication that guides a user, indicating that the work prediction line should coincide with the guidance line.

FIG. 26 is a diagram schematically illustrating an example of a superimposed video including a warning indication warning that a work prediction line does not coincide with a guidance line.

FIG. 27 is a diagram schematically illustrating an example of a superimposed video including a guidance indication that prompts a user to change a target path.

FIG. 28 is a diagram schematically illustrating an example of a superimposed video including an indication of a turning site located in the travel direction of a work vehicle.

### DETAILED DESCRIPTION OF THE EXAMPLE EMBODIMENTS

As used herein, the term “agricultural machine” refers to a machine that is used in agricultural applications. Examples of agricultural machines include tractors, harvesters, rice transplanters, vehicles for crop management, vegetable transplanters, mowers, seeders, spreaders, agricultural drones (i.e., unmanned aerial vehicles: UAVs), and mobile robots for agriculture. Not only may a work vehicle (such as a tractor) alone serve as an “agricultural machine,” but also a work vehicle combined with an implement attached to or towed by the work vehicle may serve as a single “agricultural machine.” The agricultural machine performs agricultural work such as tillage, seeding, pest controlling, manure spreading, crop planting, or harvesting on the ground surface within fields. Such types of agricultural work are in some cases referred to as “ground work” or simply as “work.” The traveling of a vehicle-type agricultural machine while performing agricultural work is in some cases referred to as “work-traveling.”

The term “automated driving” means controlling the movement of an agricultural machine under the control of a controller, without manual operations performed by the driver. An agricultural machine that performs automated driving is in some cases referred to as an “automated-driving agricultural machine” or “robot agricultural machine.” During automated driving, not only the movement of an agricultural machine but also agricultural work operations (e.g., operations of an implement) may be automatically controlled. In the case in which an agricultural machine is a vehicle-type machine, the traveling of the agricultural machine by automated driving is referred to as “automatic traveling.” The controller may be configured or programmed to control at least one of steering required for the movement of an agricultural machine, adjustment of movement speed, and starting and stopping of movement. When controlling a work vehicle with an implement attached thereto, the controller may be configured or programmed to control operations such as raising and lowering of the implement, and starting and stopping of the operation of the implement. Movement by automated driving may include not only the movement of an agricultural machine along a predetermined path toward a destination, but also the movement of an agricultural machine to follow a tracked target. An agricultural machine that performs automated driving may move partially based on the user's instructions. An agricultural machine that performs automated driving may operate in an automated driving mode as well as a manual driving mode in which the agricultural machine moves according to the driver's manual operations. Steering of an agricultural machine that is not manually performed and is instead performed under the control of the controller is referred to as “automatic steering.” All or a portion of the controller may be provided external to the agricultural machine. Control signals, commands, data, and the like may be exchanged by communication between the agricultural machine and the controller external to the agricultural machine. An agricultural machine that performs automated driving may move autonomously while sensing a surrounding environment without any human being involved with control of the movement of the agricultural machine. An agricultural machine capable of moving autonomously can perform unmanned traveling inside fields or outside fields (e.g., on roads). Such an agricultural machine may detect and avoid obstacles during autonomous movement.

The term “remote operation” or “remote maneuver” refers to operating an agricultural machine using a remote operation device. Remote operation may be performed by an operator (e.g., a system manager or a user of an agricultural machine) who is located away from an agricultural machine. The term “remotely-operated traveling” means that an agricultural machine travels in response to a signal transmitted from a remote operation device. The remote operation device may be inclusive of devices having a signal transmission function such as personal computers (PCs), laptop computers, tablet computers, smartphones, or remote controls. The operator can give an agricultural machine a command to start, stop, accelerate, decelerate, change travel direction, or the like by operating the remote operation device. The mode in which the controller controls the traveling of an agricultural machine in response to these commands is referred to as a “remote operation mode”.

The term “remote device” refers to a device that is located away from an agricultural machine, and has a communication function. Remote devices may, for example, be a remote operation device that is used by an operator to remotely maneuver an agricultural machine. The remote device may include a display device (display) or may be connected to a display device. The display device can display an image (or video) obtained by visualizing a state of surroundings of an agricultural machine based on sensor data (also referred to as “sensing data”) output from a sensor such as a camera or LiDAR sensor included in the agricultural machine. The operator can recognize the state of surroundings of the agricultural machine and remotely maneuver the agricultural machine by operating the remote operation device if necessary while viewing the displayed image.

The term “work plan” refers to data that specifies a plan for performing one or more types of agricultural work using agricultural machines. The work plan may, for example, include information indicating the order of the types of agricultural work to be performed by agricultural machines and a field in which each type of agricultural work is to be performed. The work plan may include information indicating the date and time when each type of agricultural work is to be performed. In particular, the work plan including information indicating the date and time when each type of agricultural work is to be performed is referred to as a “work schedule” or simply as a “schedule.” The work schedule may include information indicating the time when each type of agricultural work is to be started and/or the time when each type of agricultural work is to be ended on each working day. The work plan or work schedule may include information indicating, for each type of agricultural work, the contents of the work, an implement to be used, and/or the type and amount of an agricultural material to be used. As used herein, the term “agricultural material” refers to a material that is used in agricultural work performed by an agricultural machine. The agricultural material may also be simply referred to as a “material.” The agricultural material may be inclusive of materials consumed by agricultural work such as agricultural chemicals, fertilizers, seeds, or seedlings. The work plan may be created by a processing device that communicates with an agricultural machine to manage agricultural work, or a processing device mounted on an agricultural machine. The processing device can, for example, create a work plan based on information input by a user (agricultural business manager, agricultural worker, etc.) operating a terminal device. As used herein, the processing device that communicates with an agricultural machine to manage agricultural work is referred to as a “management device.” The management device may manage agricultural work of a plurality of agricultural machines. In that case, the management device may create a work plan including information about each type of agricultural work to be performed by each of the plurality of agricultural machines. The work plan may be downloaded to each agricultural machine and stored in a storage device. In order to perform scheduled agricultural work in accordance with the work plan, each agricultural machine can automatically move to a field and perform the agricultural work.

The term “environmental map” refers to data representing a position or area of an object existing in an environment where an agricultural machine moves, using a predetermined coordinate system. The environmental map may be simply referred to as a “map” or “map data.” A coordinate system that is used to specify an environmental map may, for example, be a world coordinate system such as a geographic coordinate system fixed to the earth. The environmental map may contain, in addition to positions, other information (e.g., attribute information and other information) about objects existing in an environment. The environmental map includes various types of maps such as point cloud maps and grid maps. Data of a local map or partial map created or processed during a process of producing an environmental map is also referred to as a “map” or “map data.”

The term “agricultural road” means a road that is used mainly for agriculture. The agricultural road is not limited to a road paved with asphalt, and is inclusive of unpaved roads covered with soil, gravel or the like. The agricultural road is inclusive of roads (including private roads) on which only vehicle-type agricultural machines (e.g., work vehicles such as tractors) are allowed to travel, and roads on which general vehicles (cars, trucks, buses, etc.) are also allowed to travel. Work vehicles may automatically travel on general roads in addition to agricultural roads. The term “general road” refers to a road maintained for traffic of general vehicles.

Example embodiments of the present disclosure will be described below. To avoid unnecessarily obscuring the present disclosure, well-known features may not be described or substantially the same elements may not be redundantly described, for example. This is for ease of understanding the present disclosure. The present inventor provides the accompanying drawings and the following description to allow a person skilled in the art to thoroughly understand the present disclosure. These are not intended to limit the subject matter as set forth in the appended claims. In the description that follows, like elements are indicated by like reference signs.

The following example embodiments are illustrative, and techniques according to the present disclosure are not limited thereto. For example, numerical values, shapes, materials, steps, and the order of the steps, etc., indicated in the following example embodiments are merely illustrative, and various modifications can be made thereto unless a technical contradiction occurs. The example embodiments can be used in various combinations unless a technical contradiction occurs.

Example embodiment in which the techniques according to the present disclosure are applied to a work vehicle such as a tractor, which is an example of an agricultural machine, will be mainly described below. The techniques according to the present disclosure are applicable to not only tractors but also other agricultural machines (e.g., rice transplanters, combines, harvesters, vehicles for crop management, vegetable transplanters, mowers, seeders, spreaders, agricultural drones, and mobile robots for agriculture), and particularly suitably applicable to agricultural machines that can perform remotely-operated traveling. As an example, an example embodiment in which a work vehicle is provided with a travel control system for implementing an automatic traveling function and a remote operation function will be described below. It should be noted that the techniques according to the present disclosure do not necessarily require the automatic travel function and the remote operation function. At least a portion of the functions of the travel control system may be implemented in other devices that communicate with the work vehicle (e.g., a remote device for remote maneuver, or a server).

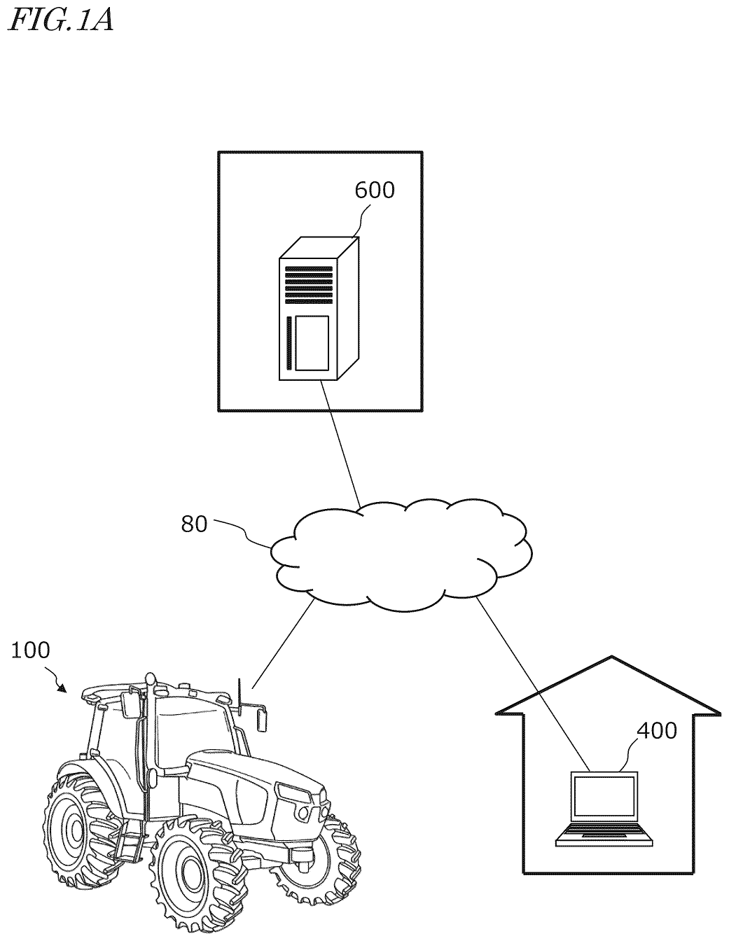

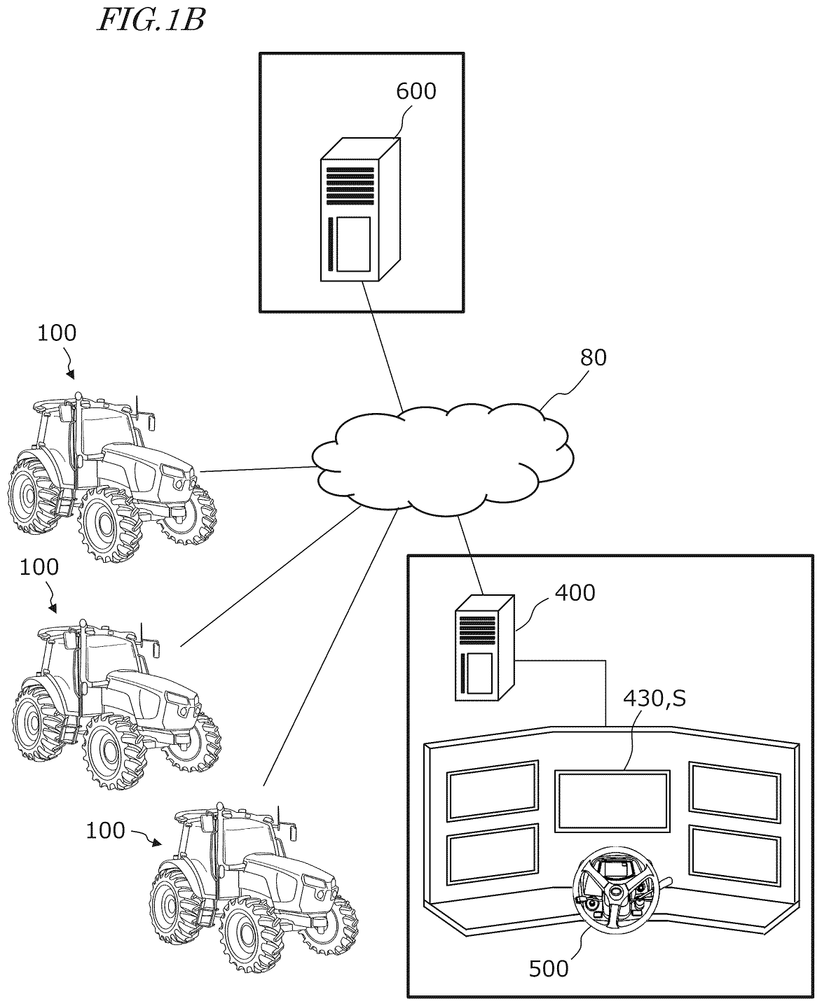

FIG. 1A is a diagram for an overview of an agriculture management system according to an illustrative example embodiment of the present disclosure. The agriculture management system illustrated in FIG. 1A includes a work vehicle 100, a remote device 400, and a management device 600. The remote device 400 is a computer used by a user who remotely monitors the work vehicle 100. The management device 600 is a computer managed by an entity running the agricultural management system. The work vehicle 100, the remote device 400, and the management device 600 can communicate with each other through a network 80. Although FIG. 1A illustrates a single work vehicle 100, the agricultural management system may include a plurality of work vehicles or other agricultural machines. The agriculture management system according to this example embodiment of the present disclosure includes a remote maneuver system for the work vehicle 100. The remote maneuver system includes a sensor, communication device, and controller of the work vehicle 100, and the remote device 400. A portion of the entire remove maneuver system according to this example embodiment of the present disclosure that includes the sensor and communication device of the work vehicle 100 is in some cases referred to as a “sensing system.” Thus, the sensing system is a portion of the remote maneuver system.

In this example embodiment of the present disclosure, the work vehicle 100 is a tractor. An implement can be attached to one or both of rear and front portions of the work vehicle 100. The work vehicle 100 can travel in a field while performing agricultural work corresponding to the type of the implement.

In this example embodiment of the present disclosure, the work vehicle 100 has an automated driving function. Specifically, the work vehicle 100 can travel under the control of the controller without manual operations. In this example embodiment of the present disclosure, the controller is provided in the work vehicle 100, and can be configured or programmed to control both the speed and steering of the work vehicle 100. The work vehicle 100 can automatically travel not only inside fields but also outside fields (e.g., roads). The mode in which the controller causes the work vehicle 100 to automatically travel is referred to as an “automatic traveling mode.”

The work vehicle 100 further has a remotely-operated traveling function. The controller is configured or programmed to control a travel device of the work vehicle 100 in response to remote operations performed by the user using the remote device 400, to change the travel speed and travel direction of the work vehicle 100. The work vehicle 100 can perform remotely-operated traveling not only outside fields but also inside fields. The mode in which the controller causes the work vehicle 100 to perform remotely-operated traveling is referred to as a “remote operation mode.”

The work vehicle 100 includes a device that is used to perform positioning or ego position estimation, such as a GNN receiver or LiDAR sensor. In the automatic travel mode, the controller of the work vehicle 100 causes the work vehicle 100 to automatically travel based on the position of the work vehicle 100 and information about a target path generated by the management device 600. The controller is configured or programmed to control the operation of an implement in addition to control of the traveling of the work vehicle 100. As a result, the work vehicle 100 can perform agricultural work using an implement while automatically traveling in a field. Furthermore, the work vehicle 100 can automatically travel on roads (e.g., agricultural roads or general roads) outside fields along a target path. When the work vehicle 100 automatically travels along a road outside fields, the work vehicle 100 travels along a target path while generating a local path along which obstacles can be avoided, based on data output from a sensor such as a camera or LiDAR sensor. The work vehicle 100 may also travel in fields while generating a local path, or may be operated to travel along a target path without generating a local path, and stop when an obstacle is detected.

The management device 600 is a computer that manages agricultural work performed by the work vehicle 100. The management device 600 may, for example, be a server computer that performs centralized management on information about fields in a cloud, and assists in agriculture using data in the cloud. For example, the management device 600 can create a work plan for the work vehicle 100, and create a target path for the work vehicle 100 according to the work plan. Alternatively, the management device 600 may generate a target path for the work vehicle 100 in response to the user's operation using the remote device 400.

The remote device 400 is a computer that is used by a user who is located away from the work vehicle 100. The remote device 400 illustrated in FIG. 1A is, but not limited to, a laptop computer. The remote device 400 may be a stationary computer, such as a desktop personal computer (PC), or a mobile terminal, such as a smartphone or tablet computer.

The remote device 400 is used to remotely monitor the work vehicle 100 or remotely operate the work vehicle 100. For example, the remote device 400 can display, on a display device, a video captured by at least one camera provided in the work vehicle 100. The user can check a situation around the work vehicle 100 by viewing the video, and sends an instruction to stop, start, accelerate, decelerate, or change the travel direction to the work vehicle 100.

FIG. 1B is a diagram illustrating another example of the agricultural management system. The agricultural management system illustrated in FIG. 1B includes a plurality of work vehicles 100. Although FIG. 1B illustrates three work vehicles 100, the number of work vehicles 100 is not particularly limited. The system may include agricultural machines (e.g., an agricultural drone) different from the work vehicle 100. In the example of FIG. 1B, the remote device 400 is not a household terminal device, and is a computer that is provided in a center to remotely monitor agricultural machines. The remote device 400 may be connected to a remote maneuver machine 500 and at least one display 430 that are used by an operator in the remote monitoring center. Although FIG. 1B illustrates five displays 430, the number of displays 430 is not particularly limited. The remote maneuver machine 500 may include various apparatuses for remotely maneuvering the work vehicles 100 (e.g., a steering wheel, accelerator pedal, left and right brake pedals, clutch pedal, and various switches or levers). Although the remote maneuver machine 500 illustrated in FIG. 1B is a device that imitates an operation apparatus that is used in manual operations of the work vehicle 100, the remote maneuver machine 500 is not limited to such a device. For example, remote maneuver may be performed using a controller such as a joystick. Each display 430 can, for example, display an environmental map of an area including a field in which the work vehicles 100 perform agricultural work, and an image (e.g., moving images) captured by at least one camera mounted on the work vehicles 100. The operator can recognize a situation around the work vehicles 100 while viewing images displayed on the displays 430. The operator can remotely maneuver each agricultural machine, e.g., switches between the automatic traveling mode and the remote operation mode, depending on a situation around each work vehicle 100.

A configuration and operation of the system according to this example embodiment of the present disclosure will be described below in more detail.

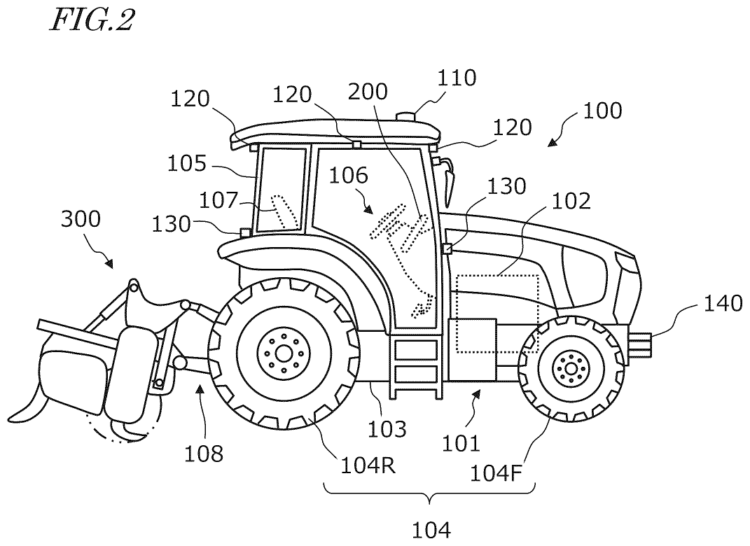

FIG. 2 is a side view schematically illustrating an example of an work vehicle 100 and an implement 300 connected to the work vehicle 100. In this example embodiment of the present disclosure, the work vehicle 100 can operate both in a manual driving mode and an automated driving mode. In the automated driving mode, the work vehicle 100 can perform unmanned traveling. The work vehicle 100 can perform automated driving both inside and outside fields. In the automated driving mode, the controller can be configured or programmed to operate in an automatic traveling mode in which the work vehicle 100 is caused to travel along a preset target path, and in a remote operation mode in which the work vehicle 100 is caused to travel in response to the user's operation using the remote device 400. The user may, for example, be the user of the work vehicle 100 or an operator in the remote monitoring center. Switching between the automatic traveling mode and the remote operation mode may be carried out by the user performing a predetermined operation using the remote device 400. For example, when the user performs an operation of instructing to start remote operation using the remote device 400 in the automatic traveling mode, the controller is configured or programmed to transition to the remote operation mode. When the user performs an operation of instructing to start automatic traveling using the remote device 400 in the remote operation mode, the controller is configured or programmed to transition to the automatic traveling mode.

As illustrated in FIG. 2, the work vehicle 100 includes a vehicle body 101, a prime mover (engine) 102, and a transmission 103. The vehicle body 101 is provided with a travel device including tire-mounted wheels 104, and a cabin 105. The travel device includes four wheels 104, axles to rotate the four wheels, and brakes to slow or stop the axles. The wheels 104 include a pair of front wheels 104F and a pair of rear wheels 104R. In the cabin 105, a driver's seat 107, a steering device 106, an operation terminal 200, and switches for operations are provided. One or both of the front wheel 104F and the rear wheel 104R may be replaced by a plurality of wheels to which a continuous track is attached (crawler) instead of a tire-mounted wheel.

The work vehicle 100 can switch between a four-wheel drive (4 W) mode in which all of the front wheels 104F and the rear wheels 104R are a driven wheel, and a two-wheel drive (2 W) mode in which the front wheels 104F or the rear wheels 104R are a driven wheel. The work vehicle 100 can also switch between a state in which the left and right brakes are linked together and a state in which the linkage is removed. When the linkage of the left and right brakes is removed, the left and right wheels 104 can be slowed or stopped separately. As a result, turning with a small turning radius can be performed.

The work vehicle 100 includes a plurality of sensors that sense surroundings of the work vehicle 100. In the example illustrated in FIG. 2, the sensors include a plurality of cameras 120, a LiDAR sensor 140, and a plurality of obstacle sensors 130. The sensor may include only a portion of the camera 120, the LiDAR sensor 140, and the obstacle sensor 130. The sensor senses an environment around the vehicle body to output sensing data.

The cameras 120 may, for example, be provided at front, rear, right, and left portions of the work vehicle 100. The cameras 120 capture an image of an environment around the work vehicle 100, and generate image data. As used herein, image data generated by the camera 120 may be simply referred to as an “image.” In addition, “generate image data by capturing an image” is in some cases referred to as “obtain an image.” Images obtained by the cameras 120 may be transmitted to the remote device 400 for remote monitoring. The images may be used to monitor the work vehicle 100 during unmanned driving. The camera 120 may also be used to generate an image for recognizing objects on the ground, obstacles, white lines, signs, indications, or the like around the work vehicle 100 when the work vehicle 100 is traveling on a road (an agricultural road or general road) outside fields.

In the example illustrated in FIG. 2, the LiDAR sensor 140 is disposed on a bottom portion of a front surface of the vehicle body 101. The LiDAR sensor 140 may be disposed at other positions. While the work vehicle 100 is traveling mainly outside fields, the LiDAR sensor 140 repeatedly outputs sensor data indicating distances to and directions of measurement points of objects existing in a surrounding environment, or the two-dimensional or three-dimensional coordinate values of the measurement points, while the work vehicle 100 is traveling. The sensor data output from the LiDAR sensor 140 is processed by the controller of the work vehicle 100. The controller can be configured or programmed to perform ego position estimation on the work vehicle 100 by performing matching between the sensor data and an environmental map. The controller can be configured or programmed to detect an object such as an obstacle existing around the work vehicle 100 based on the sensor data, and generate a local path along which the work vehicle 100 is to actually travel, along a target path (also referred to as a “global path”). The controller can be configured or programmed to generate or edit an environmental map by utilizing an algorithm such as simultaneous localization and mapping (SLAM). The work vehicle 100 may include a plurality of LiDAR sensors disposed at different positions and orientations.

In FIG. 2, the plurality of obstacle sensors 130 are provided at a front portion and a rear portion of the cabin 105. Obstacle sensors 130 may be arranged at other portions. For example, one or more obstacle sensors 130 may be provided at any position of a side portion, front portion, and rear portion of the vehicle body 101. The obstacle sensor 130 may, for example, include a laser scanner or ultrasonic sonar. The obstacle sensor 130 is used to detect surrounding obstacles during automatic traveling to cause the work vehicle 100 to stop, or circumvent the obstacles. The LiDAR sensor 140 may be used as one of the obstacle sensors 130.

The work vehicle 100 further includes a GNSS unit 110. The GNSS unit 110 includes a GNN receiver. The GNN receiver may include an antenna that receives signals from GNSS satellites, and a processor configured or programmed to calculate the position of the work vehicle 100 based on the signals received by the antenna. The GNSS unit 110 receives satellite signals transmitted from a plurality of GNSS satellites, and performs positioning based on the satellite signals. the GNSS unit 110 may be provided at an upper portion of the cabin 105 in this example embodiment, and may be provided at other positions.

The GNSS unit 110 may include an inertial measurement device (IMU). The position data may be supplemented using a signal from the IMU. The IMU can measure a tilt and minute motion of the work vehicle 100. By supplementing the position data based on satellite signals using data obtained by the IMU, positioning performance can be improved.

The controller of the work vehicle 100 may be configured or programmed to use sensing data obtained by a sensor such as the camera 120 or the LiDAR sensor 140 in addition to the result of positioning by the GNSS unit 110. In the case in which there are objects on the ground serving as a feature point in an environment in which the work vehicle 100 travels, such as an agricultural road, forest road, general road, or orchard, the position and orientation of the work vehicle 100 can be estimated with high precision based on data obtained by the camera 120 or the LiDAR sensor 140, and an environmental map previously stored in a storage device. By correcting or supplementing position data based on satellite signals using data obtained by the camera 120 or the LiDAR sensor 140, the position of the work vehicle 100 can be determined with higher precision.

The prime mover 102 may, for example, be a diesel engine. An electric motor may be used instead of the diesel engine. The transmission 103 is capable of changing the propelling force and movement speed of the work vehicle 100 by changing gear ratios. The transmission 103 is also capable of allowing the work vehicle 100 to switch between forward movement and rearward movement.

The steering device 106 includes a steering wheel, a steering shaft connected to the steering wheel, and a power steering device that provides assistance in steering of the steering wheel. The front wheels 104F are steered wheels. By changing the steering angle of the front wheels 104F, the direction in which the work vehicle 100 travels can be changed. The steering angle of the front wheels 104F can be changed by operating the steering wheel. The power steering device includes a hydraulic device or electric motor that supplies an assistive force for changing the steering angle of the front wheels 104F. When automatic steering is performed, the steering angle can be automatically adjusted by the force of the hydraulic device or electric motor under the control of the controller provided in the work vehicle 100.

A connecting device 108 is provided at a front portion of the vehicle body 101. The connecting device 108 includes, for example, a three-point support device (also referred to as a “three-point linkage” or “three-point hitch”), a power take-off (PTO) shaft, a universal joint, and a communication cable. The connecting device 108 can be used to removably connect an implement 300 to the work vehicle 100. The connecting device 108 can change the position or orientation of the implement 300 by raising or lowering the three-point linkage using, for example, a hydraulic device. In addition, power can be transmitted from the work vehicle 100 to the implement 300 through the universal joint. While towing the implement 300, the work vehicle 100 allows the implement 300 to perform predetermined work. A connecting device may also be provided at a front portion of the vehicle body 101. In that case, an implement can be connected in front of the work vehicle 100.

Although the implement 300 illustrated in FIG. 2 is a rotary tiller, the implement 300 is not limited to a rotary tiller. For example, any arbitrary implement such as a seeder, spreader, transplanter, mower, rake implement, baler, harvester, sprayer, or harrow may be connected to the work vehicle 100 for use.

The work vehicle 100 illustrated in FIG. 2 can be driven by manned driving, or alternatively, may only be capable of performing unmanned driving. In that case, components that are only required for manned driving such as the cabin 105, the steering device 106, and the driver's seat 107 do not need to be provided in the work vehicle 100. An unmanned work vehicle 100 may travel by autonomous driving or a user's remote operation.

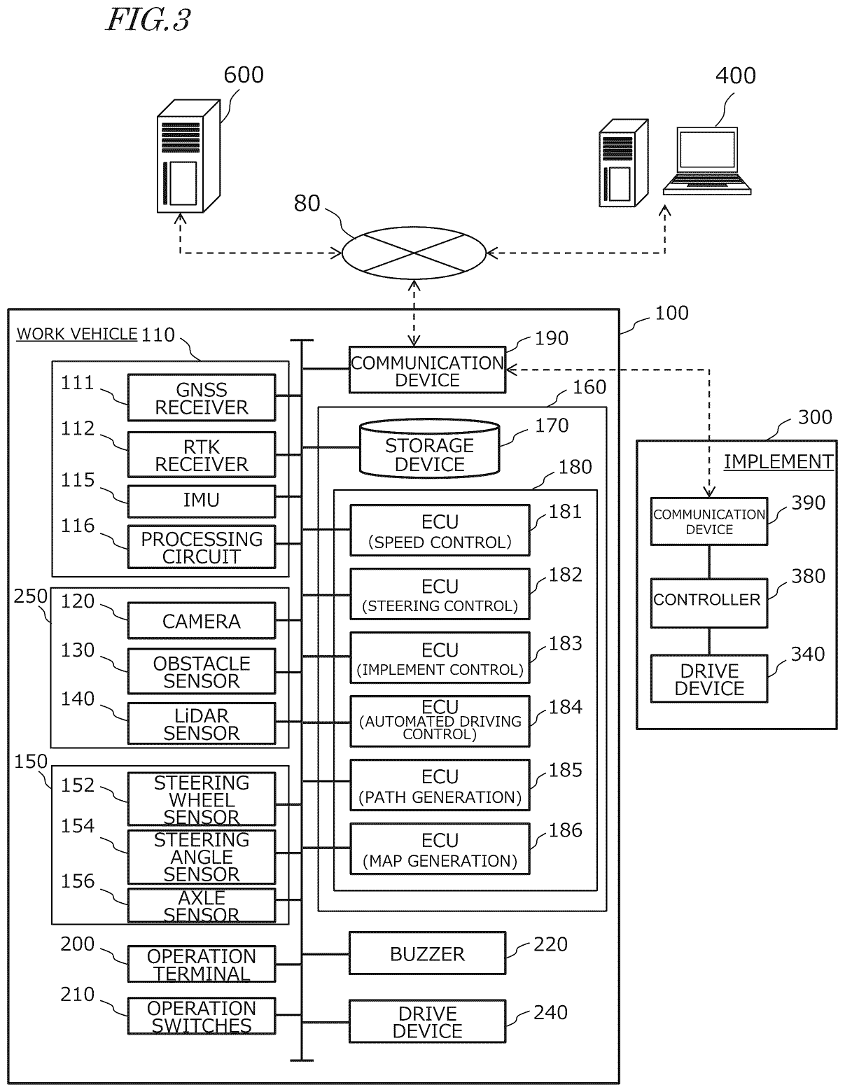

FIG. 3 is a block diagram illustrating an example configuration of the work vehicle 100 and the implement 300. The work vehicle 100 and the implement 300 can communicate with each other through the communication cable included in the connecting device 108. The work vehicle 100 can communicate with the remote device 400 and the management device 600 through the network 80.

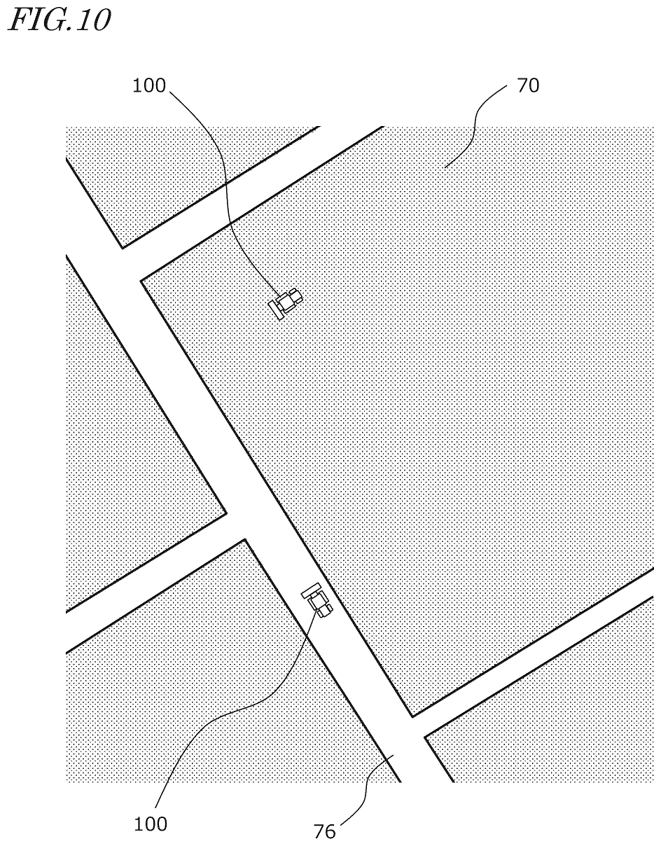

In the example of FIG. 10, the work vehicle 100 includes, in addition to a GNSS unit 110, a sensor 250 (the camera 120, the obstacle sensor 130, and the LiDAR sensor 140), and an operation terminal 200, sensors 150 that detect an operation state of the work vehicle 100, a travel control system 160, a communication device 190, operation switches 210, a buzzer 220, and a drive device 240. These components are connected so as to communicate with each other through a bus. The GNSS unit 110 includes a GNN receiver 111, an RTK receiver 112, an inertial measurement device (IMU) 115, and a processing circuit 116. The sensors 150 include a steering wheel sensor 152, a steering angle sensor 154, and an axle sensor 156. The travel control system 160 includes a storage device 170 and a controller 180. The controller 180 may be configured or programmed to include a plurality of electronic control units (ECUs) 181 to 186. The implement 300 includes a drive device 340, a controller 380, and a communication device 390. It should be noted that FIG. 3 illustrates components that are highly involved with automated driving and remote maneuver of the work vehicle 100, but not the other components.

The GNSS receiver 111 in the GNSS device 110 receives satellite signals transmitted from a plurality of GNSS satellites, and generates GNSS data based on the satellite signals. The GNSS data may be generated in a predetermined format such as the NMEA-0183 format. The GNSS data may include, for example, the identification number, elevation angle, azimuth angle, and value indicating a reception intensity of each of the satellites from which the satellite signals have been received.

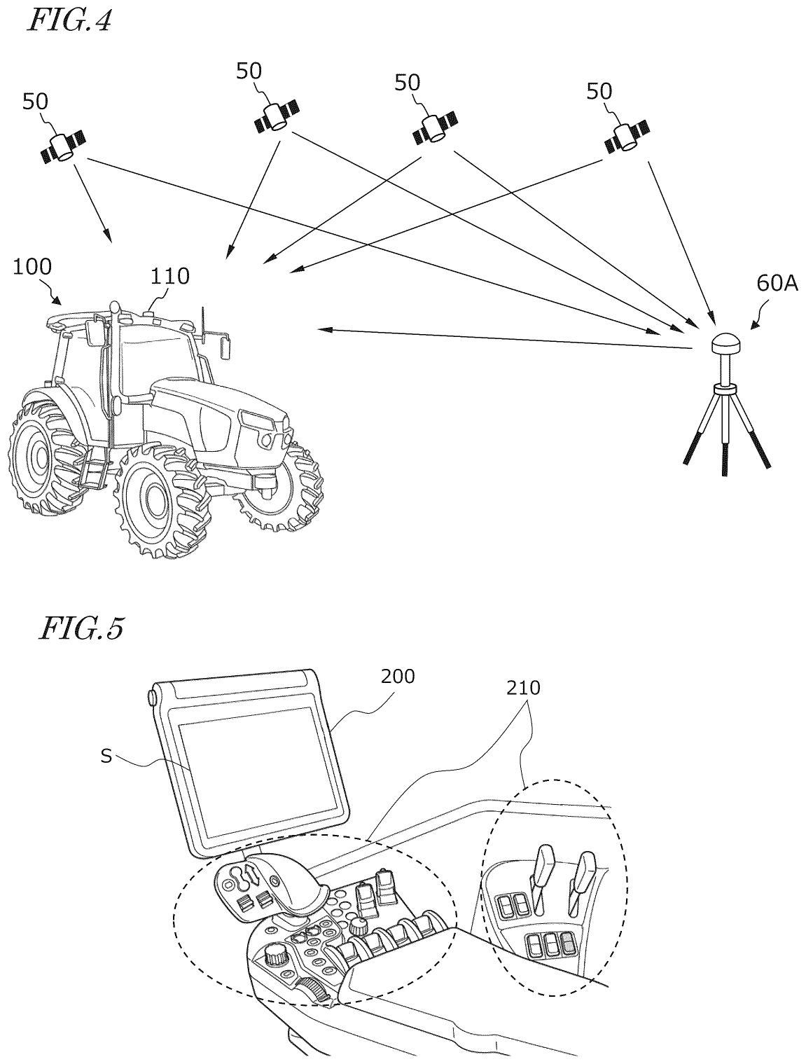

The GNSS unit 110 illustrated in FIG. 3 performs positioning on the work vehicle 100 by utilizing real-time kinematic (RTK)-GNSS. FIG. 4 is a conceptual diagram illustrating an example of the work vehicle 100 performing positioning based on RTK-GNSS. In the positioning based on RTK-GNSS, not only satellite signals transmitted from a plurality of GNSS satellites 50, but also a correction signal that is transmitted from a reference station 60A, are used. The reference station 60A may be installed near a field in which the work vehicle 100 travels (e.g., at a position within 10 km of the work vehicle 100). The reference station 60A generates a correction signal in, for example, an RTCM format based on the satellite signals received from the plurality of GNSS satellites 50, and transmits the correction signal to the GNSS unit 110. The RTK receiver 112, which includes an antenna and a modem, receives the correction signal transmitted from the reference station 60A. Based on the correction signal, the processing circuit 116 of the GNSS unit 110 corrects the result of positioning performed by the GNSS receiver 111. The use of RTK-GNSS enables positioning with a precision on the order of several centimeters of error, for example. Positional information including latitude, longitude, and altitude information is obtained through highly precise positioning performed based on RTK-GNSS. The GNSS unit 110 calculates the position of the work vehicle 100 at a frequency of, for example, about 1 to 10 times per second.

It should be noted that the positioning method is not limited to RTK-GNSS, and any positioning method (e.g., an interferometric positioning method or a relative positioning method) that provides positional information with the required precision may be used. For example, positioning may be performed using a virtual reference station (VRS) or a differential global positioning system (DGPS). In the case in which positional information having the required precision can be obtained without the use of the correction signal transmitted from the reference station 60A, positional information may be generated without the use of the correction signal. In that case, the GNSS unit 110 may not include the RTK receiver 112.

Even in the case in which RTK-GNSS is used, at a spot where the correction signal cannot be obtained from the reference station 60A (e.g., on a road far from the field), the position of the work vehicle 100 is estimated by another method without using the signal from the RTK receiver 112. For example, the position of the work vehicle 100 may be estimated by performing matching between data output from the LiDAR sensor 140 and/or the camera 120 and a high-precision environmental map.

The GNSS unit 110 in this example embodiment of the present disclosure further includes the IMU 115. The IMU 115 may include a 3-axis accelerometer and a 3-axis gyroscope. The IMU 115 may include a direction sensor such as a 3-axis geomagnetic sensor. The IMU 115 functions as a motion sensor that can output signals representing parameters such as the acceleration, velocity, displacement, and orientation of the work vehicle 100. The processing circuit 116 can estimate the position and orientation of the work vehicle 100 with a higher precision based on the satellite signals and the correction signal and, in addition, a signal output from the IMU 115. The signal output from the IMU 115 may be used for correction or supplementation of the position calculated based on the satellite signals and the correction signal. The IMU 115 outputs a signal more frequently than the GNSS receiver 111. By utilizing the more frequent signals, the processing circuit 116 allows more frequent measurements (e.g., at least 10 Hz) of the position and orientation of the work vehicle 100. Instead of the IMU 115, a 3-axis accelerometer and a 3-axis gyroscope may be separately provided. The IMU 115 may be provided separately from the GNSS unit 110.

The camera 120 is an imaging device that captures an image of an environment around the work vehicle 100. The camera 120 includes an image sensor, such as a charge coupled device (CCD) or a complementary metal oxide semiconductor (CMOS), for example. In addition, the camera 120 may include an optical system including at least one lens, and a signal processing circuit. When the work vehicle 100 is traveling, the camera 120 captures an image of an environment around the work vehicle 100, and generates image data (e.g., moving image data). The camera 120 can capture moving images at a frame rate of at least 3 frames per second (fps), for example. The images generated by the camera 120 may be used when a remote monitor checks an environment around the work vehicle 100 using the remote device 400, for example. The images generated by the camera 120 may also be used for positioning and/or obstacle detection. As illustrated in FIG. 2, a plurality of cameras 120 may be provided on the work vehicle 100 at different positions, or a single camera may be provided. A visible camera, which generates visible light images, and an infrared camera, which generates infrared images, may be separately provided. Both a visible camera and an infrared camera may be provided as a camera for generating images for monitoring purposes. The infrared camera may also be used for detection of obstacles at nighttime.

The obstacle sensor 130 detects objects existing around the work vehicle 100. The obstacle sensor 130 may, for example, include a laser scanner or ultrasonic sonar. When an object exists at a position within a predetermined distance from the obstacle sensor 130, the obstacle sensor 130 outputs a signal indicating the presence of the obstacle. A plurality of obstacle sensors 130 may be provided on the work vehicle 100 at different positions. For example, a plurality of laser scanners and a plurality of ultrasonic sonars may be arranged on the work vehicle 100 at different positions. By providing a number of obstacle sensors 130 in such a manner, blind spots in monitoring obstacles around the work vehicle 100 can be reduced.

The steering wheel sensor 152 measures the angle of rotation of the steering wheel of the work vehicle 100. The steering angle sensor 154 measures the steering angle of the front wheels 104F, which are steered wheels. Measurement values obtained by the steering wheel sensor 152 and the steering angle sensor 154 are used for steering control performed by the controller 180.

The axle sensor 156 measures the rotational speed, i.e., the number of revolutions per unit time, of an axle that is connected to the wheels 104. The axle sensor 156 may, for example, employ a magnetoresistive element (MR), a Hall element, or an electromagnetic pickup. The axle sensor 156 outputs a numerical value indicating the number of revolutions per minute (unit: rpm) of the axle, for example. The axle sensor 156 is used to measure the speed of the work vehicle 100.

The drive device 240 includes various types of devices required to cause the work vehicle 100 to travel such as the prime mover 102, the transmission 103, and the steering device 106, and various types of devices required to drive the implement 300 such as the connecting device 108. The prime mover 102 may include an internal combustion engine, such as a diesel engine. The drive device 240 may include an electric motor for traction instead of or in addition to the internal combustion engine.

The buzzer 220 is an audio output device to make a warning sound to notify the user of an abnormality. For example, the buzzer 220 may make a warning sound when an obstacle is detected during automated driving. The buzzer 220 is controlled by the controller 180.

The storage device 170 includes at least one storage medium, such as a flash memory or magnetic disc. The storage device 170 stores various types of data that are generated by the GNSS unit 110, the camera 120, the obstacle sensor 130, the LiDAR sensor 140, the sensors 150, and the controller 180. The data that is stored by the storage device 170 includes map data of an environment in which the work vehicle 100 travels (environmental map), and data of a global path (target path) for automated driving. The environmental map includes information about a plurality of fields in which the work vehicle 100 performs agricultural work and roads around the fields. The environmental map and the target path may be generated by a processing device (i.e., a processor) in the management device 600. It should be noted that in this example embodiment of the present disclosure, the controller 180 may have the function of generating or editing the environmental map and the target path. The controller 180 can edit the environmental map and target path obtained from the management device 600 based on a travel environment of the work vehicle 100.

The storage device 170 also stores data of a work plan received by the communication device 190 from the management device 600. The work plan includes information about a plurality of types of agricultural work to be performed by the work vehicle 100 over a plurality of working days. The work plan may, for example, be data of a work schedule including information about the time when the work vehicle 100 is scheduled to perform each type of agricultural work on each working day. The storage device 170 also stores a computer program for causing each ECU in the controller 180 to execute various operations described below. Such a computer program may be provided to the work vehicle 100 through a storage medium (e.g., a semiconductor memory, optical disc, etc.) or a telecommunication line (e.g., the Internet). Such a computer program may be sold as commercial software.

The controller 180 may be configured or programmed to include a plurality of ECUs. The plurality of ECUs may, for example, include an ECU 181 for speed control, an ECU 182 for steering control, an ECU 183 for implement control, and an ECU 184 for automated driving control, an ECU 185 for path generation, and an ECU 186 for map generation.

The ECU 181 controls the prime mover 102, the transmission 103, and brakes included in the drive device 240 to control the speed of the work vehicle 100.

The ECU 182 controls the hydraulic device or electric motor included in the steering device 106 based on a measurement value obtained by the steering wheel sensor 152 to control steering of the work vehicle 100.

The ECU 183 controls the operation of the three-point linkage, the PTO shaft, and the like that are included in the connecting device 108 in order to cause the implement 300 to perform the desired operation. The ECU 183 also generates a signal for controlling the operation of the implement 300, and transmits the signal from the communication device 190 to the implement 300.

The ECU 184 performs computation and control for achieving automated driving based on data output from the GNSS unit 110, the camera 120, the obstacle sensor 130, the LiDAR sensor 140, and the sensors 150. For example, the ECU 184 determines the position of the work vehicle 100 based on data output from at least one of the GNSS unit 110, the camera 120, and the LiDAR sensor 140. In fields, the ECU 184 may determine the position of the work vehicle 100 only based on data output from the GNSS unit 110. The ECU 184 may estimate or correct the position of the work vehicle 100 based on data obtained by the camera 120 and the LiDAR sensor 140. By utilizing the data obtained by the camera 120 and the LiDAR sensor 140, the precision of positioning can be further improved. In fields, the ECU 184 may estimate the position of the work vehicle 100 based on data output from the LiDAR sensor 140 or the camera 120. For example, the ECU 184 may estimate the position of the work vehicle 100 by performing matching between data output from the LiDAR sensor 140 or the camera 120 and an environmental map. During automated driving, the ECU 184 performs computation required for traveling of the work vehicle 100 along a target path or a local path, based on the estimated position of the work vehicle 100. The ECU 184 sends a command to change the speed to the ECU 181, and a command to change the steering angle to the ECU 182. In response to the command to change the speed, the ECU 181 controls the prime mover 102, the transmission 103, or the brakes to change the speed of the work vehicle 100. In response to the command to change the steering angle, the ECU 182 controls the steering device 106 to change the steering angle.

The ECU 184 also performs control related to the remotely-operated traveling of the work vehicle 100. In the remote operation mode, the ECU 184 controls the ECUs 181, 182, and 183 in response to a signal that is received by the communication device 190 from the remote device 400. As a result, operations such as speed control and steering control of the work vehicle 100, raising and lowering of the implement 300, and switching on/off of the implement 300 can be carried out in response to the user's remote operation.

While the work vehicle 100 is traveling along the target path, the ECU 185 sequentially generates local paths along which the work vehicle 100 can avoid obstacles. During traveling of the work vehicle 100, the ECU 185 recognizes an obstacle existing around the work vehicle 100 based on the data output from the camera 120, the obstacle sensor 130, and the LiDAR sensor 140. The ECU 185 generates a local path such that the work vehicle 100 avoids the recognized obstacle.

The ECU 185 may have a function of performing global path planning instead of the management device 160. In that case, the ECU 185 may determine a destination of the work vehicle 100 based on a work schedule stored in the storage device 170, and determine a target path from a position where the work vehicle 100 starts moving to the destination. The ECU 185 can, for example, generate a path along which the work vehicle 100 can reach the destination within the shortest period of time, as a target path, based on an environmental map including information about roads stored in the storage device 170. Alternatively, the ECU 185 may generate, as a target path, a path including a particular type(s) of road (e.g., roads along particular objects on the ground such as agricultural roads and waterways, and roads on which satellite signals can be satisfactorily received from a GNSS satellite) with higher priority, based on attribute information of roads included in an environmental map.

The ECU 186 generates or edits a map of an environment in which the work vehicle 100 travels. In this example embodiment of the present disclosure, an environmental map generated by an external device such as the management device 600 is transmitted to the work vehicle 100 and recorded in the storage device 170. Instead, the ECU 186 can generate or edit an environmental map. An operation in the case in which the ECU 186 generates an environmental map will be described below. An environmental map may be generated based on sensor data output from the LiDAR sensor 140. When generating an environmental map, the ECU 186 sequentially generates three-dimensional point cloud data based on sensor data output from the LiDAR sensor 140 while the work vehicle 100 is traveling. The ECU 186 can generate an environmental map by concatenating the pieces of point cloud data sequentially generated by utilizing an algorithm such as SLAM. The environmental map thus generated is a high-precision three-dimensional map, and may be used in ego position estimation performed by the ECU 184. Based on this three-dimensional map, a two-dimensional map that is used in global path planning may be generated. As used herein, the three-dimensional map that is used in ego position estimation and the two-dimensional map that is used in global path planning will both be referred to as an “environmental map.” The ECU 186 can further edit a map by adding, to the map, various types of attribute information relating to objects on the ground (e.g., waterways, rivers, grasses, and trees), the type of a road (e.g., whether or not the road is an agricultural road), the state of the road surface, the passability of a road, and the like the like, which are recognized based on data output from the camera 120 or the LiDAR sensor 140.

By the operations of these ECUs, the controller 180 allows automatic traveling and remotely-operated traveling. During automatic traveling, the controller 180 is configured or programmed to control the drive device 240 based on the measured or estimated position of the work vehicle 100 and the generated path. As a result, the controller 180 can cause the work vehicle 100 to travel along the target path. During remotely-operated traveling, the controller 180 controls traveling of the work vehicle 100 based on a signal transmitted from the remote device 400. In other words, the controller 180 is configured or programmed to control the drive device 240 in response to the user's operation using the remote device 400. As a result, the controller 180 can be configured or programmed to cause the work vehicle 100 to travel in accordance with the user's instruction.

The plurality of ECUs included in the controller 180 can communicate with each other in accordance with a vehicle bus standard, such as the controller area network (CAN). Instead of CAN, faster communication methods such as automotive Ethernet (registered trademark) may be used. Although the ECUs 181 to 184 are illustrated as individual blocks in FIG. 3, the function of each of the ECUs 181 to 186 may be implemented by a plurality of ECUS. Alternatively, an onboard computer in which at least a portion of the functions of the ECUs 181 to 186 are integrated may be provided. The controller 180 may include other ECUs in addition to the ECUs 181 to 186, and may include any number of ECUs according to functions. Each ECU includes a processing circuit including at least one processor.

The communication device 190 includes a circuit that communicates with the implement 300, the terminal device 400, and the management device 600. The communication device 190 transmits sensing data output from the sensor 250 to the remove device 400. The communication device 190 includes a circuit that exchanges signals conforming to an ISOBUS standard such as ISOBUS-TIM between itself and the communication device 390 of the implement 300. This allows the implement 300 to perform the desired operation, or acquisition of information from the implement 300. The communication device 190 may further include an antenna and a communication circuit for exchanging signals through the network 80 with communication devices of the remote device 400 and the management device 600. The network 80 may, for example, include a cellular mobile communication network such as 3G, 4G, or 5G, and the Internet. The communication device 190 may have the function of communicating with a mobile terminal that is used by a monitor who is located near the work vehicle 100. Between the communication device 190 and such a mobile terminal, communication may be performed in accordance with any wireless communication standard, such as Wi-Fi (registered trademark), a cellular mobile communication standard (e.g., 3G, 4G, or 5G), or Bluetooth (registered trademark).

The operation terminal 200 is used by the user to perform operations related to the traveling of the work vehicle 100 and the operation of the implement 300, and may also be referred to as a virtual terminal (VT). The operation terminal 200 may include a display device such as a touchscreen, and/or at least one button. The display device may, for example, be a liquid crystal display or organic light-emitting diode (OLED) display. By operating the operation terminal 200, the user can perform various operations such as switching on/off the automated driving mode, switching on/off the remote operation mode, recording or editing an environmental map, setting a target path, and switching on/off the implement 300. At least a portion of these operations may also be performed by operating the operation switches 210. The operation terminal 200 may be configured so as to be removed from the work vehicle 100. A user who is located away from the work vehicle 100 may operate the removed operation terminal 200 to control the operation of the work vehicle 100. Instead of the operation terminal 200, the user may operate a computer on which required application software has been installed, such as the remote device 400, to control the operation of the work vehicle 100.

FIG. 5 is a diagram illustrating an example of the operation terminal 200 and the operation switches 210, which are provided in the cabin 105. In the cabin 105, the operation switches 210, including a plurality of switches that can be operated by the user, are disposed. The operation switches 210 may, for example, include a switch to choose a gear ratio for a main or sub transmission, a switch to switch between the automated driving mode and the manual driving mode, a switch to switch between forward traveling and backward traveling, a switch to switch between four-wheel drive and two-wheel drive, a switch to remove the linkage of the left and right brakes, and a switch to raise or lower the implement 300. It should be noted that in the case in which the work vehicle 100 only performs unmanned driving and does not have the manned driving function, the work vehicle 100 does not need to include the operation switches 210.

At least a portion of operations that can be carried out by the operation terminal 200 or the operation switches 210 may also be carried out by remote operations using the remote device 400. Any of the operations may be carried out by the user performing a predetermined operation on a screen displayed on the display of the remote device 400.

The drive device 340 in the implement 300 illustrated in FIG. 3 performs operations required for the implement 300 to perform predetermined work. The drive device 340 includes a device suitable for the purpose of the implement 300, such as a hydraulic device, electric motor, or pump. The controller 380 is configured or programmed to control the operation of the drive device 340. In response to a signal transmitted from the work vehicle 100 through the communication device 390, the controller 380 causes the drive device 340 to perform various operations. The controller 380 can also be configured or programmed to transmit a signal corresponding to a state of the implement from the 300 communication device 390 to the work vehicle 100.

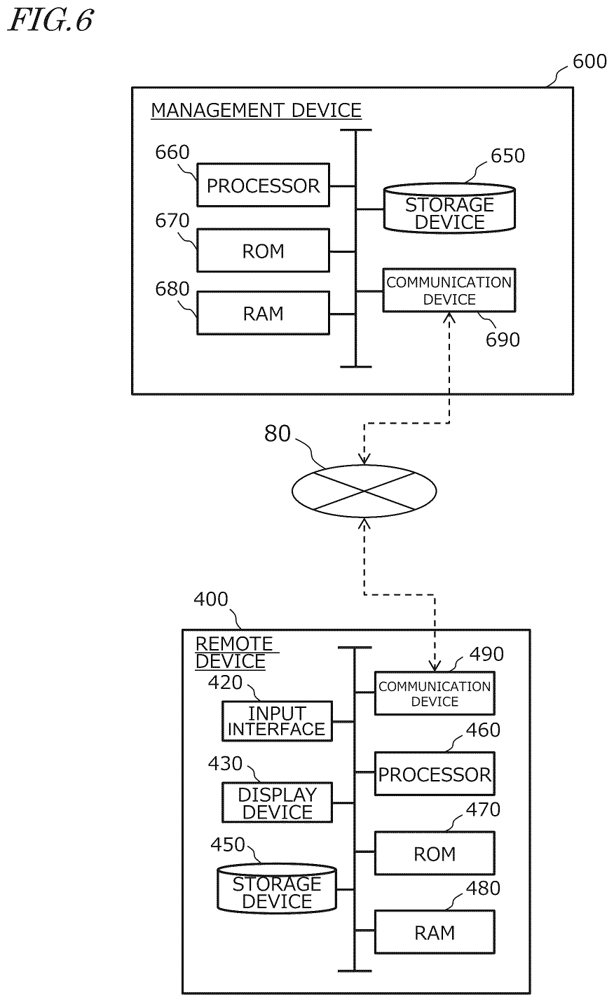

Next, configurations of the management device 600 and the remote device 400 will be described with reference to FIG. 6. FIG. 6 is a block diagram illustrating example schematic hardware configurations of the management device 600 and the remote device 400.

The management device 600 includes a storage device 650, a processor 660, a read only memory (ROM) 670, a random access memory (RAM) 680, and a communication device 690. These components are communicably connected to each other through a bus. The management device 600 may function as a cloud server to manage the schedule of agricultural work to be performed by the work vehicle 100 in a field, and assist in agriculture using data managed by the management device 600 itself. The user can input information required for creation of a work plan using the remote device 400, and upload the information to the management device 600 through the network 80. The management device 600 can create a schedule of agricultural work, that is, a work plan based on that information. The management device 600 can also generate or edit an environmental map and perform global path planning for the work vehicle 100. The environmental map may be distributed from a computer external to the management device 600.

The communication device 690 is a communication module that allows communication between the work vehicle 100 and the remote device 400 through the network 80. The communication device 690 can perform wired communication conforming to a communication standard such as IEEE1394 (registered trademark) or Ethernet (registered trademark). The communication device 690 may perform wireless communication conforming to Bluetooth (registered trademark) or Wi-Fi, or cellular mobile communication conforming to 3G, 4G, 5G, or the like.

The processor 660 may, for example, be an integrated circuit including a central processing unit (CPU). The processor 660 may be implemented by a microprocessor or microcontroller. Alternatively, the processor 660 may be implemented by a field programmable gate array (FPGA), graphics processing unit (GPU), application specific integrated circuit (ASIC), application specific standard product (ASSP), or a combination of two or more selected from these circuits. The processor 660 sequentially executes a computer program in which commands to execute one or more processes are described, and which is stored in the ROM 670, thereby carrying out a desired process.

The ROM 670 is, for example, writable memory (e.g., PROM), rewritable memory (e.g., flash memory), or read only memory. The ROM 670 stores a program that controls the operation of the processor 660. The ROM 670 does not need to be a single storage medium, and may be a set of storage media. A portion of the set of storage media may be a removable memory.

The RAM 680 provides a work area in which the control program stored in the ROM 670 is temporarily loaded during booting. The RAM 680 does not need to be a single storage medium, and may be a set of storage media.

The storage device 650 mainly serves as a storage for a database. The storage device 650 may, for example, be a magnetic storage device or semiconductor storage device. An example of the magnetic storage device is a hard disk drive (HDD). An example of the semiconductor storage device is a solid state drive (SSD). The storage device 650 may be separate from the management device 600. For example, the storage device 650 may be connected to the management device 600 through the network 80, and may, for example, be a cloud storage.

The remote device 400 illustrated in FIG. 6 includes an input interface 420, a display device (display) 430, a storage device 450, a processor 460, a ROM 470, a RAM 480, and a communication device 490. These components are communicably connected to each other through a bus. The input interface 420 converts an instruction from the user into data, and inputs the data into a computer. The input interface 420 may, for example, be a keyboard, mouse, or touchscreen. The display device 430 may, for example, be a liquid crystal display or organic EL display. The processor 460, the ROM 470, the RAM 480, the storage device 450, and the communication device 490 are substantially the same as the corresponding components described above regarding the example hardware configurations of the management device 600, and will not be described.

In the example of FIG. 6, the remote device 400 is a computer including a display and an input interface as illustrated in FIG. 1A. As illustrated in FIG. 1B, the remote device 400 may be a computer connected to the remote maneuver machine 500 and the display 430 in the remote monitoring center.

Operations of the work vehicle 100, the remote device 400, and the management device 600 will be described below.

Firstly, an example operation of automatic traveling of the work vehicle 100 will be described. The work vehicle 100 according to this example embodiment of the present disclosure can automatically travel both inside and outside fields. Inside fields, the work vehicle 100 drives the implement 300 to perform predetermined agricultural work while traveling along a preset target path. When an obstacle is detected by the obstacle sensor 130 while the work vehicle 100 is traveling in a field, the work vehicle 100 stops traveling and performs operations of making a warning sound from the buzzer 220, transmitting a warning signal to the remote device 400, and the like. Inside fields, the positioning of the work vehicle 100 is performed mainly based on data output from the GNSS unit 110. Meanwhile, outside fields, the work vehicle 100 automatically travels along a target path to be set for an agricultural road or general road outside fields. When the work vehicle 100 is traveling outside fields, the work vehicle 100 performs local path planning based on data obtained by the camera 120 or the LiDAR 140. When an obstacle is detected outside fields, the work vehicle 100 avoids the obstacle or stops at the spot. Outside fields, the position of the work vehicle 100 is estimated based on positioning data output from the GNSS unit 110, and in addition, data output from the LiDAR sensor 140 or the camera 120.

An operation of the work vehicle 100 when automatically traveling inside a field will first be described below, before an operation of the work vehicle 100 automatically traveling outside fields will be described.

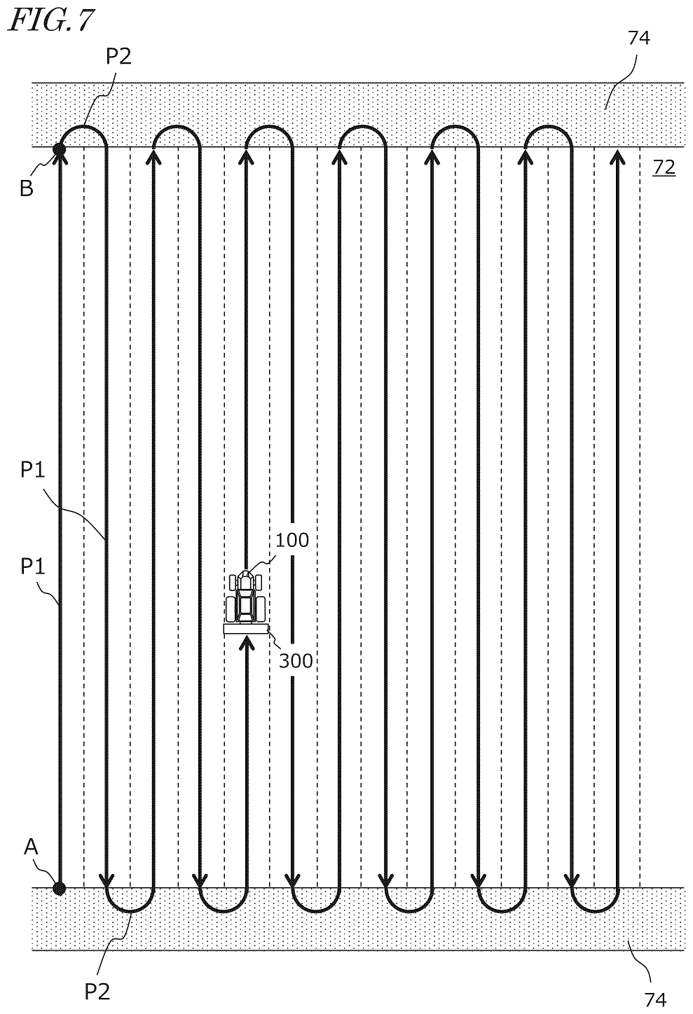

FIG. 7 is a diagram schematically illustrating an example of the work vehicle 100 automatically traveling along a target path in a field. In this example, the field includes a work area 72 in which the work vehicle 100 performs work using the implement 300, and headlands 74 that are located near an outer edge of the field. The user may previously specify, on a map, which area of a field corresponds to a work area 72 or a headlands 74. In this example, a target path includes a plurality of main paths P1 parallel to each other and a plurality of turning paths P2 connecting the plurality of main paths P1 together. The main paths P1 are located in the work area 72, and the turning paths P2 are located in the headlands 74. Although each main path P1 in FIG. 7 is illustrated as a linear path, each main path P1 may also include a curved portion(s). The main paths P1 may, for example, be automatically generated by the user performing an operation of specifying two points (in FIG. 7, points A and B) at or near an end of a field while viewing a map of the field displayed on the operation terminal 200 or the remote device 400. In that case, the main paths P1 are set in parallel with the line segment connecting the points A and B specified by the user, and a target path in the field is generated by connecting the main paths P1 together by the turning paths P2. In FIG. 7, dashed lines represent a work breadth of the implement 300. The work breadth is previously set and recorded in the storage device 170. The work breadth may be set and recorded by the user operating the operation terminal 200 or the remote device 400. Alternatively, the work breadth may be automatically recognized and recorded when the implement 300 is connected to the work vehicle 100. An interval between each main path P1 may be set, depending on the work breadth. The target path may be generated based on the user's operation before the start of automated driving. The target path may, for example, be generated so as to cover the entire work area 72 in the field. Along the target path illustrated in FIG. 7, the work vehicle 100 automatically travels back and forth, from a start point to ending point of work. it should be noted that the target path illustrated in FIG. 7 is merely illustrative, and a target path may be determined in any suitable manner.

Next, an example of control by the controller 180 during automated driving in a field will be described.

FIG. 8 is a flowchart illustrating an example operation of steering control during automated driving performed by the controller 180. The controller 180 is configured or programmed to perform automatic steering by performing the operations of steps S121 to S125 of FIG. 8 while the work vehicle 100 is traveling. Concerning the speed, the speed may be maintained at a preset speed, for example. The controller 180 obtains data indicating the position of the work vehicle 100 generated by the GNSS unit 110 while the work vehicle 100 is traveling (step S121). Next, the controller 180 calculates a deviation of the position of the work vehicle 100 from a target path (step S122). The deviation represents a distance between the position at that time of the work vehicle 100 and the target path. The controller 180 determines whether or not the calculated positional deviation exceeds a preset threshold (step S123). If the deviation exceeds the threshold, the controller 180 changes the steering angle so as to reduce the deviation, by changing a control parameter of the steering device included in the drive device 240. If, in step S123, the deviation does not exceed the threshold, the operation of step S124 is not performed. In the next step S125, the controller 180 determines whether or not a command to end the operation has been received. The command to end the operation may be issued when the user instructs to stop automated driving by a remote operation, or when the work vehicle 100 reaches the destination, for example. If the command to end the operation is not issued, control returns to step S121, in which a similar operation is performed based on the newly measured position of the work vehicle 100. The controller 180 repeatedly performs the operations of steps S121 to S125 until the command to end the operation is issued. The above operations are performed by the ECUs 182 and 184 of the controller 180.

In the example of FIG. 8, the controller 180 is configured or programmed to control the drive device 240 only based on the deviation of the position of the work vehicle 100 determined by the GNSS unit 110 from the target path. This control may be performed, additionally taking a deviation in azimuth into account. For example, if an azimuthal deviation that is a difference in angle between the orientation of the work vehicle 100 determined by the GNSS unit 110, and the direction of the target path, exceeds a preset threshold, the controller 180 may change a control parameter (e.g., a steering angle) of the steering device of the drive device 240 based on the deviation.

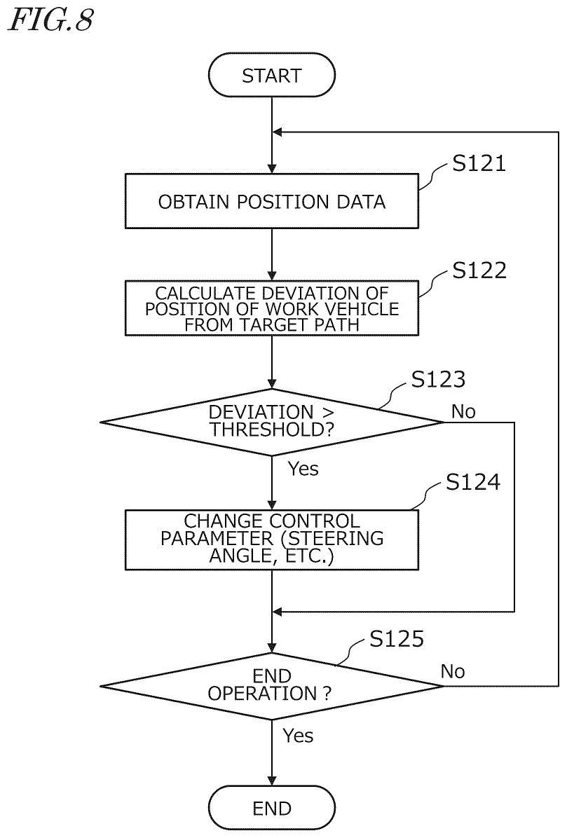

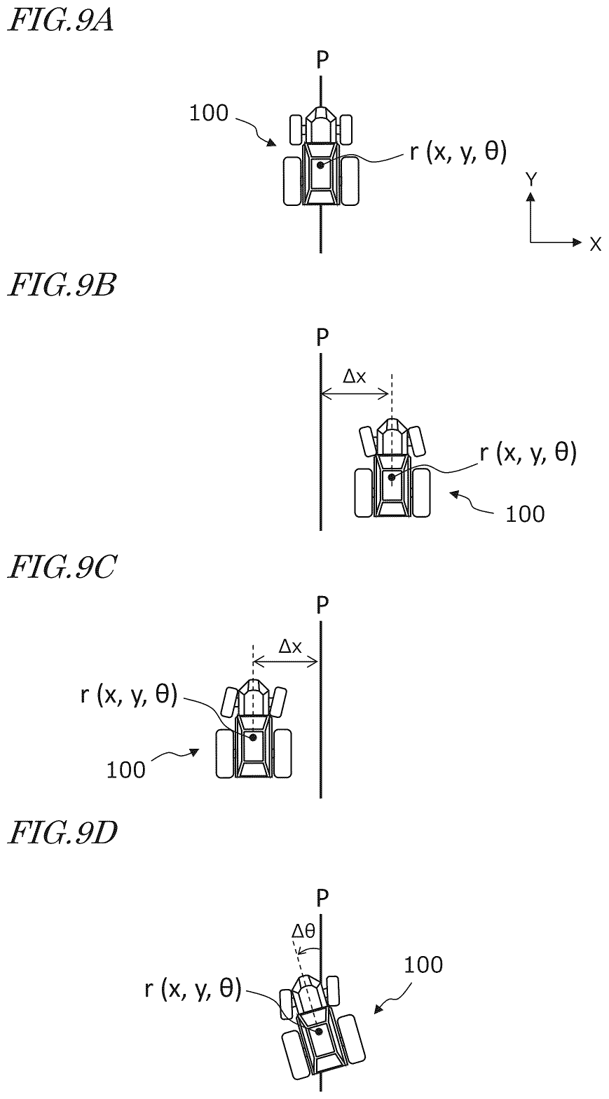

An example of the steering control performed by the controller 180 will be more specifically described below with reference to FIGS. 9A to 9D.

FIG. 9A is a diagram illustrating an example of the work vehicle 100 that travels along a target path P. FIG. 9B is a diagram illustrating an example of the work vehicle 100 that is located at a position away from and to the right of the target path P. FIG. 9C is a diagram illustrating an example of the work vehicle 100 that is located at a position away from and to the left of the target path P. FIG. 9D is a diagram illustrating an example of the work vehicle 100 that faces in a direction tilted with respect to the target path P. In these figures, a pose indicating the position and orientation of the work vehicle 100 measured by the GNSS unit 110 is represented by r(x, y, θ). (x, y) is a coordinate point representing the position of a reference point of the work vehicle 100 in an XY coordinate system that is a two-dimensional coordinate system fixed to the earth. In the example of FIGS. 9A to 9D, the reference point of the work vehicle 100 is located at the position where the GNSS antenna is provided on the cabin, but is not particularly limited. θ is an angle representing the measured orientation of the work vehicle 100. In the illustrated example, the target path P is parallel to the Y axis, but in general, is not limited to this.

As illustrated in FIG. 9A, if the position and orientation of the work vehicle 100 do not deviate from the target path P, the controller 180 maintains the steering angle and speed of the work vehicle 100 without changing them.

As illustrated in FIG. 9B, if the position of the work vehicle 100 deviates to the right of the target path P, the controller 180 changes the steering angle of the work vehicle 100 so that the travel direction of the work vehicle 100 is tilted to the left and therefore the work vehicle 100 approaches the path P. At this time, the speed may also be changed in addition to the steering angle. The value of the steering angle may, for example, be adjusted according to the value of a positional deviation Δx.

As illustrated in FIG. 9C, if the position of the work vehicle 100 deviates to the left of the target path P, the controller 180 changes the steering angle of the work vehicle 100 so that the travel direction of the work vehicle 100 is tilted to the right and therefore the work vehicle 100 approaches the path P. At this time, the speed may also be changed in addition to the steering angle. The value of the steering angle may, for example, be adjusted according to the value of a positional deviation Δx.

As illustrated in FIG. 9D, if the position of the work vehicle 100 does not significantly deviate from the target path P and the orientation of the work vehicle 100 is different from the direction of the target path P, the controller 180 changes the steering angle so as to reduce an azimuthal deviation Δθ. Also in this case, the speed may be changed in addition to the steering angle. The value of the steering angle may, for example, be adjusted according to the value of each of the positional deviation Δx and the azimuthal deviation Δθ. For example, a variation in the steering angle according to the azimuthal deviation Δθ may be increased with a decrease in the absolute value of the positional deviation Δx. If the absolute value of the positional deviation Δx is great, the steering angle is changed much in order to cause the work vehicle 100 to return to the path P, and therefore, the absolute value of the azimuthal deviation Δθ is inevitably great. Conversely, if the absolute value of the positional deviation Δx is small, the azimuthal deviation 40 needs to approach zero. Therefore, it is preferable to relatively increase the weight (i.e., a control gain) of the azimuthal deviation Δθ to determine the steering angle.

Control techniques such as PID control and MPC control (model prediction control) may be applied to the steering control and speed control of the work vehicle 100. By applying these control techniques, control that causes the work vehicle 100 to approach the target path P can be smoothly performed.

It should be noted that if at least one obstacle sensor 130 detects an obstacle during traveling, the controller 180 stops the work vehicle 100. At this time, the controller 180 may cause a buzzer 220 to make a warning sound, or may transmit a warning signal to the remote device 400. If it is possible to avoid an obstacle, the controller 180 may control the drive device 240 so as to avoid the obstacle.

The work vehicle 100 according to this example embodiment of the present disclosure can perform automatic traveling outside fields as well as inside fields. Outside fields, the controller 180 can detect an object located at a relatively distant position from the work vehicle 100 (e.g., another vehicle, a pedestrian, etc.) based on data output from the camera 120 or the LiDAR sensor 140. The controller 180 is configured or programmed to generate a local path such that the detected object can be avoided, and performs speed control and steering control along the local path. Thus, automatic traveling can be carried out on a road outside fields.

As described above, the work vehicle 100 according to this example embodiment of the present disclosure can automatically travel inside and outside fields in an unmanned manner. FIG. 10 is a diagram schematically illustrating an example of a situation in which a plurality of work vehicles 100 are automatically traveling in a field 70 and on a road 76 outside fields 70. The storage device 170 stores an environmental map of an area including a plurality of fields and roads around the fields, and a target path. The environmental map and the target path may be generated by the management device 600 or the ECU 185. When the work vehicle 100 travels on a road, the work vehicle 100 travels along the target path while sensing surroundings thereof using sensors such as the camera 120 and the LiDAR sensor 140, with the implement 300 raised. During traveling, the controller 180 sequentially generates local paths and causes the work vehicle 100 to travel along the local paths. This allows the work vehicle 100 to automatically travel while avoiding obstacles. During traveling, the target path may be changed, depending on a situation. Thus, in this example embodiment of the present disclosure, the controller can be configured or programmed to generate a target path for automatic traveling in fields and on roads around fields. In the automatic traveling mode, the controller 180 is configured or programmed to cause the work vehicle 100 to automatically travel in an automatic traveling area specified by a field and a road for which a target path has been generated.

Next, operations related to remote maneuver of the work vehicle 100 will be described.

When the work vehicle 100 is automatically traveling, the user can remotely monitor and maneuver the work vehicle 100 using the remote device 400. When the work vehicle 100 is automatically traveling, the controller 180 transmits an image (e.g., moving images) captured by at least one camera 120 mounted on the work vehicle 100 to the remote device 400 through the communication device 190. The remote device 400 displays that image on the display 430. The user can check a situation around the work vehicle 100 and start remotely-operated traveling if necessary while viewing the displayed image.

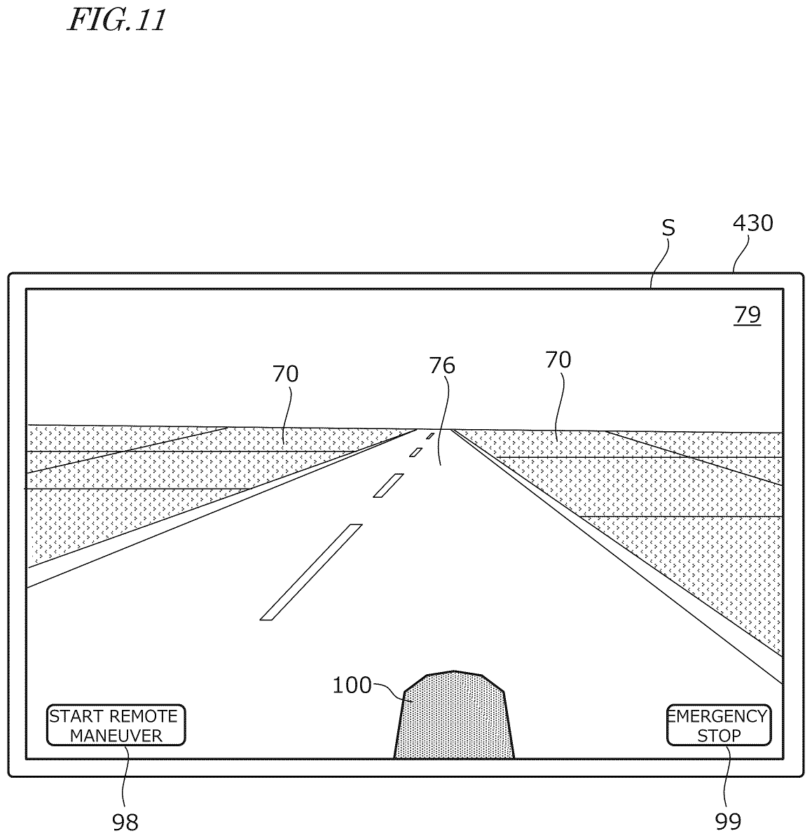

FIG. 11 is a diagram illustrating an example of an image displayed on the display 430 of the remote device 400. The image illustrated in FIG. 11 shows a field 70, a road 76, a sky 79, and a front portion of the work vehicle 100. The image is captured by the camera 120 that captures an image of an area in front of the work vehicle 100. In addition to the camera 120 that captures an image of an area in front of the work vehicle 100, an image captured by a camera 120 that captures an image of an area behind or to the right or left of the camera 120 may, for example, be displayed on the display 430. The display 430 displays moving images having a frame rate of, for example, at least 3 fps (typically, 30 fps or 60 fps, etc.). It should be noted that a plurality of images captured by a plurality of cameras 120 may be displayed on a plurality of displays. For example, as illustrated in FIG. 1B, a plurality of videos may be displayed on a plurality of displays 430 in the remote monitoring center. In that case, a user (i.e., an operator) who is a monitorer can check details of a situation around the work vehicle 100 while viewing a plurality of videos displayed on a plurality of displays 430. In addition to images captured by the camera 120, a map of an area including the work vehicle 100 may be displayed on a display.

In the example illustrated in FIG. 11, the displayed image includes a button (remote maneuver start button) 98 to instruct to start remote maneuver, and a button (emergency stop button) 99 to cause the work vehicle 100 to stop immediately. The user can cause transition from the automatic traveling mode to the remote operation mode by touching or clicking the remote maneuver start button 98. The user can also immediately stop the work vehicle 100 by touching or clicking the emergency stop button 99.

When the remote maneuver start button 98 is pressed, remote maneuver is enabled. For example, in the example of FIG. 1B, the operator can remotely maneuver the work vehicle 100 using the remote maneuver machine 500. The controller 180 is configured or programmed to cause the work vehicle 100 to perform an instructed operation in response to the user's operation.

In the above example, an image (hereinafter also referred to as a “camera image”) captured by the camera 120 mounted on the work vehicle 100 is displayed on the display 430 of the remote device 400. In addition to the camera image, an image based on point cloud data obtained by the LiDAR sensor 140 and other sensing data may, for example, be displayed on the display 430. An image based on the point cloud data indicates the distribution of objects located around the work vehicle 100, and therefore, may be used for monitoring as with camera images. The operator can recognize a situation around the work vehicle 100 based on a camera image or an image based on the point cloud data. In the following description, moving images or a video based on image data generated by the camera 120 and point cloud data generated by the LiDAR sensor 140 are in some cases referred to as “time-series images.”

A video display system according to an example embodiment of the present disclosure includes an image capture device, a screen, and a controller. The image capture device is mounted on an agricultural machine (work vehicle 100) to which an implement 300 is connected, and generates data of time-series images by capturing images of an area in the travel direction of the work vehicle 100. The controller displays, on the screen, a video based on the data of the time-series images. The controller is configured or programmed to (1) when the implement is connected to the work vehicle 100 on the opposite side from the travel direction, display, on the screen, a superimposed video in which a path for the implement is superimposed on a video, and (2) display, on the screen, a superimposed video in which an image showing a work trace after ground work in the travel direction, which is predicted during traveling of the work vehicle 100 with the implement connected thereto is superimposed on a video. For example, a camera 120 provided at a front portion of the work vehicle 100 may serve as the image capture device. The display 430 of the remote device 400 of FIG. 1B or the touchscreen of the operation terminal 200 of FIG. 5 may serve as the screen of the video display system. The controller 180 of the work vehicle 100, the processor 460 of the remote device 400, or the processor of the operation terminal 200 may serve as the controller of the video display system. The controller of the video display system is hereinafter simply referred to as a “controller.”

In this example embodiment of the present disclosure, the implement 300 is connected to a rear portion of the work vehicle 100. A video captured by the image capture device indicates an area in front of the agricultural machine. It should be noted that the implement 300 may be connected to a front portion of the work vehicle 100. In that case, a video captured by the image capture device indicates an area behind the work vehicle 100. The controller can display, on the screen, a video showing an area in front of the work vehicle 100. The controller displays, on the screen, a superimposed video in which a path and/or a work trace after ground work of the implement 300 are superimposed on the video.

The video display system according to this example embodiment of the present disclosure can display, on the screen, a superimposed video in which an image showing at least one of a path and a work trace after ground work of the implement 300 located behind the work vehicle 100, in the travel direction of the work vehicle 100, is superimposed on a video showing an area in front of the work vehicle 100. As a result, for example, the ease of remote maneuver can be improved. Different implements 300 may have different heights and widths. Even in that case, for example, the operator who operates the remote operation device can easily recognize, from the superimposed video, a future state in the travel direction of the work vehicle 100, such as a path, a work trace after ground work, or the like of the implement. Therefore, when remotely operating the work vehicle 100 inside or outside fields, the operator can, for example, easily change a target path for the work vehicle 100, start and stop the operation of the implement 300, stop traveling of the work vehicle 100, and the like.

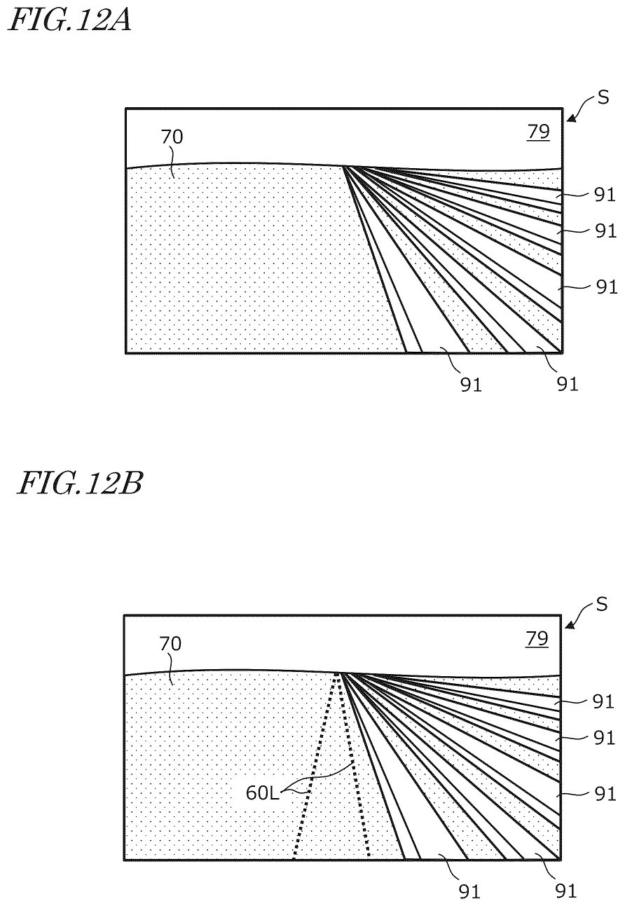

A non-limiting example of a method for displaying a superimposed video according to a first implementation example will be described with reference to FIGS. 12A to 21.

FIG. 12A is a diagram schematically illustrating an example of a video showing an area in front of the work vehicle 100, which is displayed on a screen S. FIG. 12B is a diagram schematically illustrating an example of a superimposed video in which a path for the implement 300 in the travel direction of the work vehicle 100 is superimposed on a video. The implement 300 may perform at least one of types of ground work including hilling, tillage, crop planting, and crop reaping. FIGS. 12A and 12B each illustrate a situation in which the implement 300 is performing hilling in a field 70. As illustrated in FIG. 12A, a conventional video shows a plurality of hills 91 for which work has been done and that extend in the travel direction of the work vehicle 100, and it is natural that no hills 91 have not yet been formed in the ground of the travel direction.

In the first implementation example, the controller displays, on the screen S, a superimposed video in which a path for the implement 300 when the implement 300 is connected to the work vehicle 100 on the opposite side from the travel direction is superimposed on a video. As a result, in the video displayed on the screen S, an indication showing the path for the implement 300 can be viewed on the ground in the travel direction of the work vehicle 100. In the example of FIG. 12B, the path for the implement 300 is represented by an imaginary dotted line indication 60.

FIG. 13 is a diagram schematically illustrating a positional relationship between a reference point R1 in a local coordinate system of the work vehicle 100 and the positions of both end portions of the implement 300. The local coordinate system, which is moved together with the work vehicle 100 and the implement 300, is also referred to as a mobile body coordinate system. The reference point R1 in the local coordinate system may be set at any position of the work vehicle 100. In the example of FIG. 13, the reference point R1 is set at a position where the camera 120 is arranged.

In this example embodiment of the present disclosure, when the work vehicle 100 and the implement 300, which are connected to each other, travel straight on a flat ground, the front-back direction of the vehicle is the X direction and the left-right direction of the vehicle is the Y direction in the local coordinate system. The direction from back to front is the +X direction and the direction from left to right is the +Y direction. Concerning the geometry of a device, ISO 11783 specifies that “the X axis is specified as positive in the normal driving direction,” and “the Y axis is specified as positive to the right side of the device relative to the normal driving direction.” The X direction and the Y direction in the local coordinate system may be defined based on the definition of the device geometry. The unit of coordinate values of the local coordinate system is not particularly limited, and may, for example, be millimeter. Even in a local coordinate system for the work vehicle 100 alone and a local coordinate system for the implement 300 alone, the X and Y directions and the unit of coordinate values are defined in a manner similar to that described above.

The controller is configured or programmed to obtain implement information about the implement 300, and pose information about the current pose of the work vehicle 100. The implement information includes size information of an implement. The implement information may, for example, further include specific information (e.g., model number) that can be used to identify the model of the implement 300. The size information of the implement 300 may include the sizes in the X and Y directions of the entirety of the implement 300 of FIG. 13, and height information of the implement 300. The implement information may be previously stored in a storage device of the implement 300. In this example embodiment of the present disclosure, the pose information indicates a pose that is a set of the position and orientation of the work vehicle 100 as measured using the GNSS unit 110, and is represented by the above r(x, y, θ). The work vehicle information includes size information of the work vehicle 100. The work vehicle information may, for example, further include specific information (e.g., model number) that can be used to identify the model of the work vehicle 100. The size information of the work vehicle 100 may include the sizes in the X and Y directions of the entirety of the work vehicle 100 of FIG. 13.

As described above, the work vehicle 100 and the implement 300 can, for example, communicate with each other in accordance with the ISOBUS standard. By thus communicating with the implement 300, the controller may obtain the implement information including the size of the implement 300. Alternatively, the controller may obtain the implement information including the size of the implement 300, which is input by the user through an input interface. The user may, for example, input the implement information through the input interface 420 of the remote device 400.

As illustrated in FIG. 13, positions T1 and T2 of both end portions in the width direction of the implement 300 are located a length LX behind the reference point R1. The position T1 is located a length L1Y to the left of the reference point R1, and the position T2 is located a length L2Y to the right of the reference point R1. In the first implementation example, the controller calculates the length LX based on the sizes in the X direction of the work vehicle 100 and the implement 300, and the lengths L1Y and L2Y based on the size in the Y direction of the implement 300. Thus, the controller can calculate the coordinates of the positions T1 and T2 with respect to the reference point R1 in the local coordinate system. The controller further converts the coordinate points of the positions T1 and T2 in the local coordinate system into those in a geographic coordinate system based on the pose information. The coordinate points of the positions T1 and T2 in the geographic coordinate system are each represented by a latitude and a longitude, for example.

An example of determination of a positional relationship between the reference point of a work vehicle and the position of a specific portion of an implement in a local coordinate system is specifically described in Japanese Laid-Open Patent Publication No. 2022-101030, filed by the same applicant as the present application. The entire contents of Japanese Laid-Open Patent Publication No. 2022-101030 are hereby incorporated by reference.

The r(θ) of the pose information means the azimuth angle of the travel direction of the work vehicle 100. The r(x, y) of the pose information is, for example, represented by a latitude and a longitude. The azimuth angle is, for example, represented by a clockwise angle with reference to true north. In the first implementation example, the controller predicts a path for the implement 300 based on the implement information and the pose information. For example, the controller calculates an imaginary straight line passing through the coordinate points in the geographic coordinate system of the positions T1 and T2 of both end portions of the implement 300 calculated based on the implement information and the pose information, and extending in the direction of an azimuth angle calculated based on the current pose information, and determines this straight line as a future path for the implement 300 in the travel direction of the work vehicle 100.

The controller may predict a path for the implement 300 including a path for at least one of both end portions of the implement 300. In the example of FIG. 13, the controller predicts paths for both end portions of the implement 300. The controller calculates an imaginary straight line 60L passing through the coordinate point of the position T1 in the geographic coordinate system and extending in the true north direction (θ=0), and an imaginary straight line 60R passing through the coordinate point of the position T2 in the geographic coordinate system and extending in the true north direction (θ=0). The controller determines the straight lines 60L and 60R as paths for both a left end portion and a right end portion of the implement 300. In FIG. 13, the straight lines 60L and 60R are indicated by a dotted line. It should be noted that the indication of paths for the implement 300 is not limited to lines.

In the first implementation example, the controller coordinate-converts a point cloud specifying an imaginary straight line in the geographic coordinate system indicating a path for the implement 300 into the positions of pixels in an image coordinate system. Specifically, the controller converts the coordinate points of a point cloud specifying an imaginary straight line in the geographic coordinate system into those in the local coordinate system using external parameters of a camera for converting the geographic coordinate system into the local coordinate system. The controller further converts the coordinate points of a point cloud specifying an imaginary straight line in the local coordinate system into those in the image coordinate system using internal parameters of a camera for converting the local coordinate system into the image coordinate system. As a result, a three-dimensional point cloud in the geographic coordinate system can be transferred to a two-dimensional plane in the image coordinate system. Thus, the controller can generate a superimposed video in which the straight lines 60L and 60R indicating paths for both a left end portion and a right end portion, respectively, of the implement 300 are superimposed on a video. The controller can, for example, generate a superimposed video using a real-time rendering (or real-time CG) technique.

In the above example, the controller converts the coordinate points of the positions T1 and T2 of both end portions of the implement 300 in the local coordinate system into those in the geographic coordinate system, and displays, on the screen S, paths calculated based on the positions T1 and T2 in the geographic coordinate system. It should be noted that generation of a superimposed video is not limited to this example. For example, the controller may set straight lines 60L and 60R (see FIG. 13) passing through both end portions of the implement 300 in the local coordinate system, and overlays the straight lines 60L and 60R thus set on a video obtained by the image capture device. The local coordinate system and the image coordinate system may be previously associated with each other. The controller may convert the coordinate points of the straight lines 60L and 60R in the local coordinate system into those in the image coordinate system according to that association, thus generating a superimposed video in which the straight lines 60L and 60R are superimposed on a video.

The controller may predict paths for the wheels 104 of the work vehicle 100 based on the pose information when the work vehicle 100 is traveling, and display, on the screen S, a superimposed video the paths for the wheels of the work vehicle 100 are further superimposed on a video. The work vehicle information may include information about the coordinate points in the local coordinate system of the positions of the four wheels of the work vehicle 100. In the first implementation example, the controller calculates imaginary straight lines 61L and 61R passing through the coordinate points in the local coordinate system of a pair of rear wheels 104R and extending in the direction of an azimuth angle calculated from the current pose information as in the case of a path for the implement 300. The controller determines the straight lines 61L and 61R as paths for the pair of rear wheels 104R. FIG. 13 represents the straight lines 61L and 61R by a dashed line. It should be noted that the indication of paths for the wheels 104 is not limited to lines.

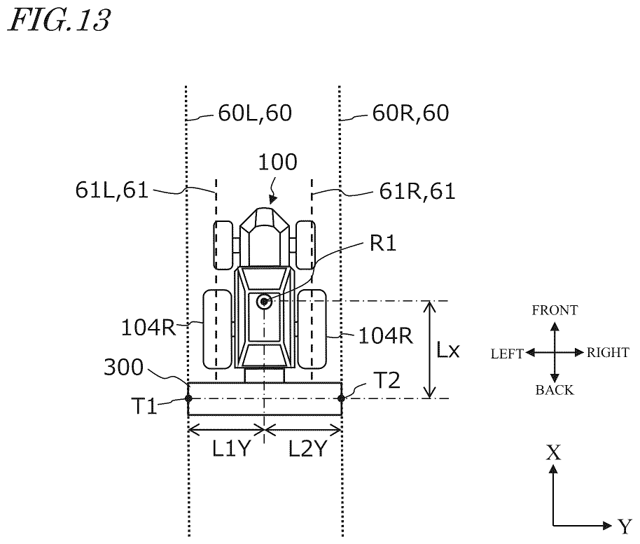

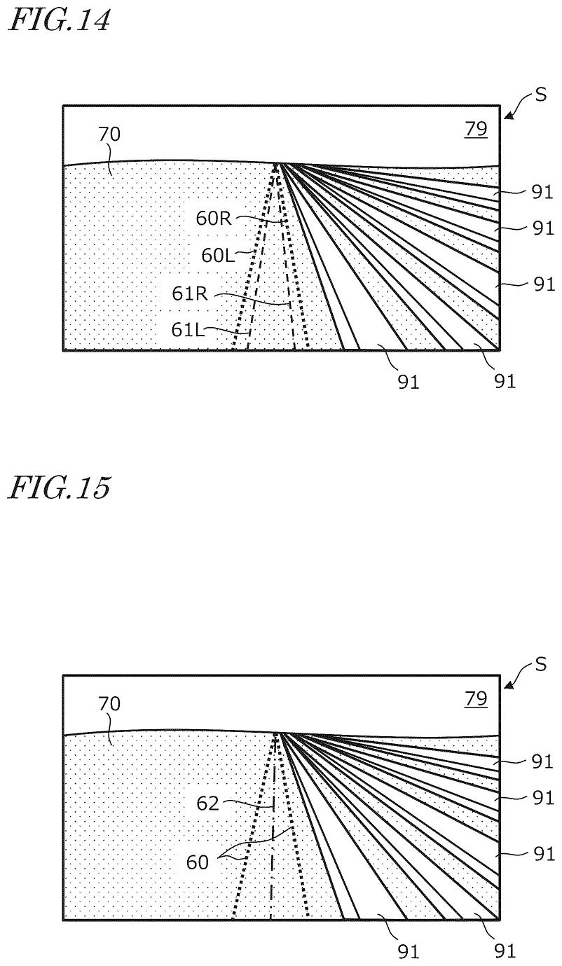

FIG. 14 is a diagram schematically illustrating an example of a superimposed video in which paths for the implement 300 and paths for the pair of rear wheels 104R are superimposed on a video. The controller can generate a superimposed video in which a line indication of paths for the pair of rear wheels 104R is further superimposed on a video, by converting the coordinate points of the straight lines 61L and 61R in the geographic coordinate system into those in the image coordinate system.

In another example in which paths for the implement 300 are indicated, the controller 180 of the work vehicle 100 may estimate paths for wheels in the image coordinate system, in a video, based on the work vehicle information, the pose information, and the like. Since a positional relationship between the wheels and the camera 120 (the reference point R1) of the work vehicle 100 is known, the controller can estimate paths for both end portions of the implement 300 from paths for the pair of rear wheels 104R in the image coordinate system based on that positional relationship.

FIG. 15 is a diagram schematically illustrating an example of a superimposed video in which paths for the implement 300 and a target line along a target path are superimposed on a video. The controller may display, on the screen S, a superimposed video in which a target line 62 along a target path that is set so as to cause the work vehicle 100 to automatically travel is further superimposed on a video. In the example of FIG. 15, the target line 62 is represented by a dash-dot line. It should be noted that the indication of the target line 62 is not limited to lines. With such a superimposed video, it may be easier to visually recognize a deviation of paths for the implement 300 from the target line.

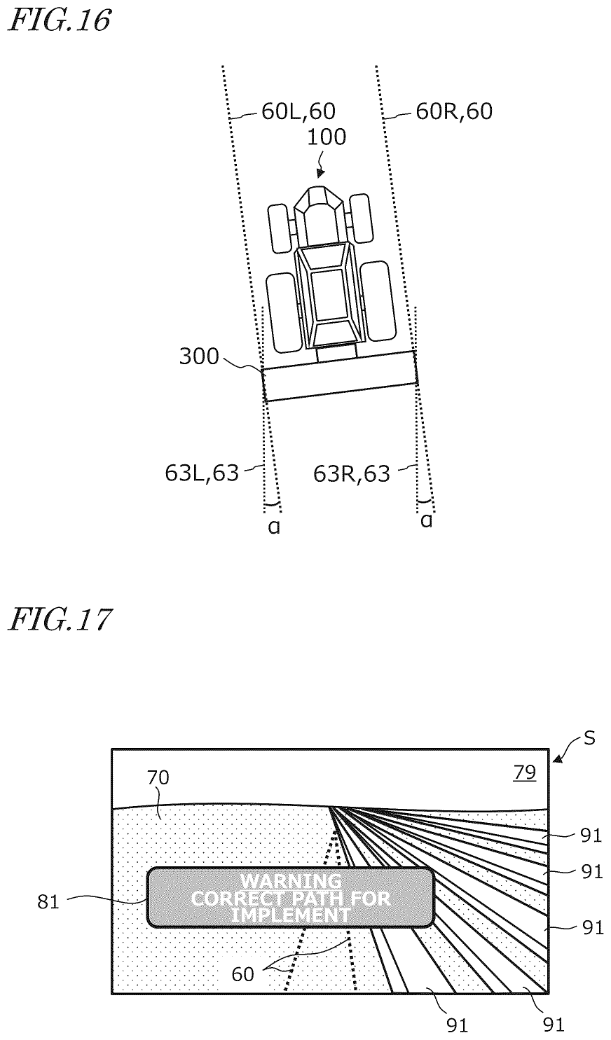

FIG. 16 is a schematic diagram for describing the amount of a deviation of predicted paths for the implement 300 from reference paths. In FIG. 16, predicted paths and reference paths for the implement 300 are represented by straight lines 60 and 63, respectively. The controller can estimate the amounts of deviations of predicted paths 60 for the implement 300 from reference paths, based on the predicted paths for the implement 300, and the reference paths predicted from the past tracks of the implement 300. For example, the controller calculates regression straight lines 63 from waypoints specifying past tracks of the implement 300 by the least squares method. The controller may determine the regression straight lines 63 as reference paths. The deviation amount may be represented by an angle α between the straight line 60 and the regression straight line 63.

The controller may provide different indications on the screen S, depending on whether or not the deviation amount is less than a threshold. When the deviation amount is less than the threshold, the controller may, for example, notify the operator that the implement 300 is properly automatically traveling along a target path, by highlighting the lines 60 indicating the paths for the implement 300.

FIG. 17 is a diagram schematically illustrating an example of a superimposed video including a warning indication 81 that is displayed on the screen S when the deviation amount is not less than the threshold. When the deviation amount is not less than the threshold, the controller may display, on the screen S, a superimposed video including a warning indication 81 warning that a predicted track for the implement 300 deviates from past tracks. The warning indication 81 may be displayed on the topmost plane of a video. In the example illustrated in FIG. 17, straight lines 60 indicating paths for the implement 300 touch an adjacent hill 91. Such a superimposed video can, for example, prompt the operator to change the target path, so that the implement 300 can be proactively prevented from touching the adjacent hill.

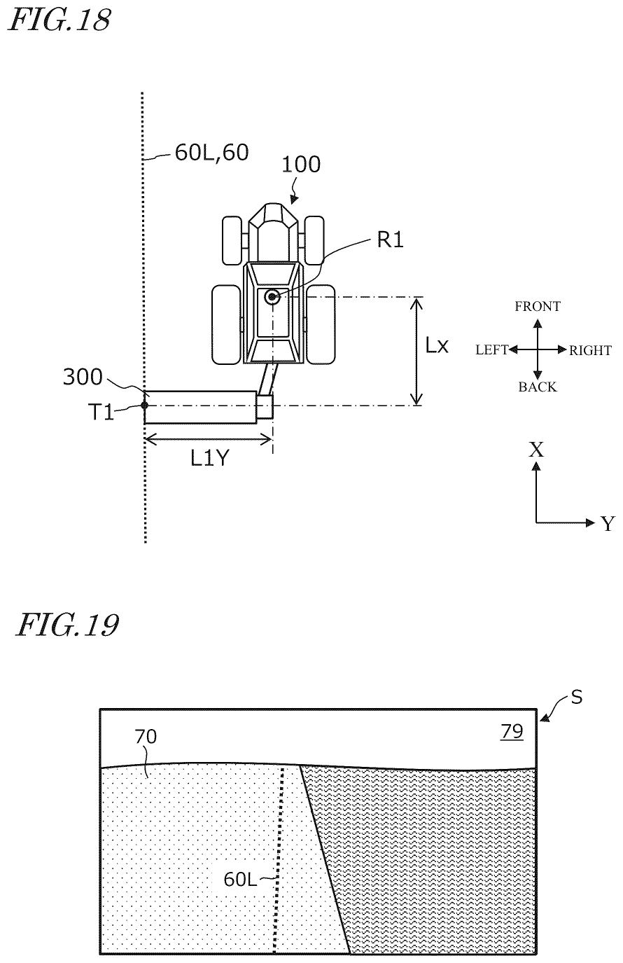

FIG. 18 is a diagram schematically illustrating a positional relationship between the reference point R1 in the local coordinate system of a work vehicle 100, and the position of one side portion of an implement 300 installed off-center. An example of the off-center implement is a plow for tillage, overturning, and plowing in conjunction with fertilization, or a mower. In the example of FIG. 18, the implement 300 is offset to the left of the middle of the work vehicle 100. As described above with reference to FIG. 13, the controller calculates the coordinate point in the geographic coordinate system of the position of the side portion T1 of the off-center implement 300 based on lengths Lx and L1Y. The controller calculates an imaginary straight line 60L passing through the coordinate point of the position T1 in the geographic coordinate system and extending in the true north direction (θ=0). The controller determines the straight line 60L as a path for the left side portion of the implement 300.

FIG. 19 is a diagram schematically illustrating an example of a superimposed video in which a path for the off-center implement 300 is superimposed on a video. FIG. 19 illustrates a situation in which mowing is being performed by the off-center implement 300. The controller may display, on the screen S, a superimposed video in which a straight line 60L indicating a path for a left side portion of the off-center implement 300 is superimposed on a video.

The video display system according to this example embodiment of the present disclosure may include a sensor that obtains sensing data indicating a distribution of objects on the ground around the work vehicle 100. The sensor may be a sensor 250 of the work vehicle 100. If there is an object on the ground in the travel direction of the work vehicle 100, the controller can estimate the size of the object based on sensing data output from the sensor. The controller may display, on the screen S, a superimposed video including a warning indication 82 warning that the implement 300 is likely to hit the object, depending on the result of comparison between the size of the implement 300 and the size of the object.

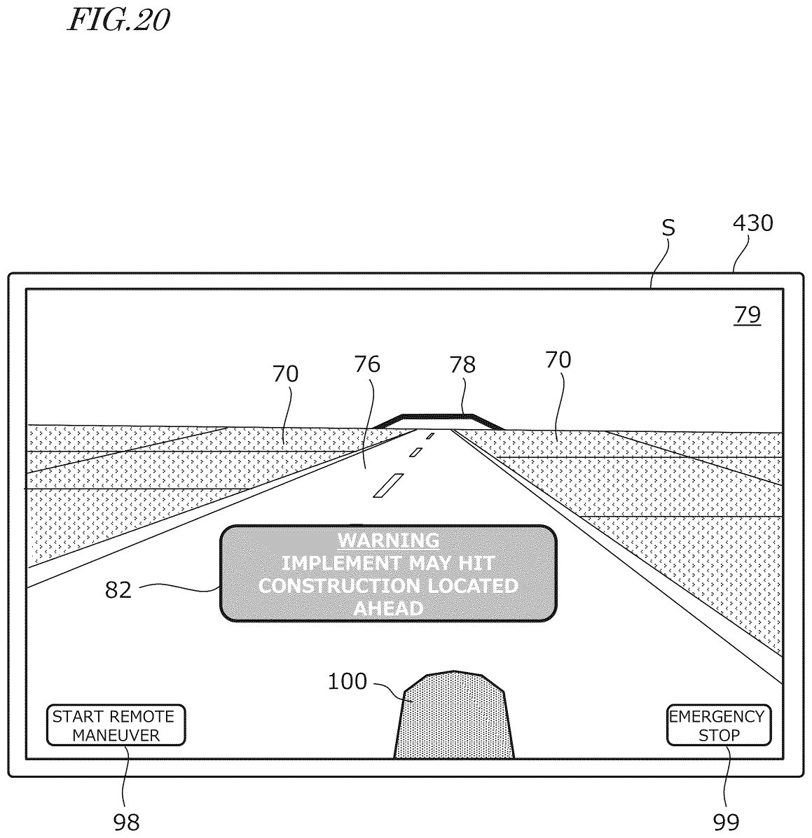

FIG. 20 is a diagram schematically illustrating an example of a video showing that there is a footbridge 78 grade-separated from a road 76 outside fields in the travel direction of a work vehicle 100 traveling on the road 76. The work vehicle 100 may travel outside fields with an implement 300 raised. Therefore, the implement 300 may hit an object located on the ground in the travel direction of the work vehicle 100, depending on the type of the implement 300. For example, the controller can estimate the height of the footbridge 78 based on sensing data output from a sensor. The controller can also estimate the height of the uppermost portion of the implement 300 with reference to the ground based on the size in the height direction of the implement 300. If the estimated height of the uppermost portion is greater than the estimated height of the footbridge 78, the controller displays, on the screen S, a superimposed video including the warning indication 82. By displaying a warning indication, it is possible to proactively avoid hitting an object on the ground.

The video display system according to this example embodiment of the present disclosure may include a light source that is controlled by the controller, and an optical system that receives light output from the light source and forms a virtual image in front of a screen. In other words, the video display system may include a HUD. A HUD that displays information in the human visual field is used to display information on the windshield of a vehicle to assist in driving.

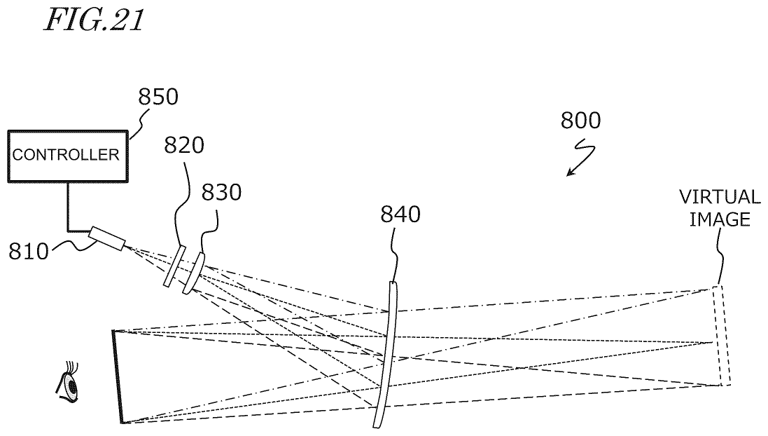

FIG. 21 is a schematic diagram illustrating an example configuration of a HUD unit. A type of HUD using or including a virtual image optical system will be described below. It should be noted that the configuration of the HUD unit is not limited to the example of FIG. 21.

A HUD unit 800 includes a light source 810, a transparent screen 820, a field lens 830, and a combiner 840. The optical system of the HUD unit 800 has the transparent screen 820, the field lens 830, and the combiner 840, and in addition, a MEME mirror, a movable lens, and the like. The HUD unit 800 is, for example, attached to the ceiling surface of the roof of the cabin of a work vehicle.

A light beam emitted from the light source 810 is focused by the transparent screen 820 to form a real image. The transparent screen 820 serves as a secondary light source, and emits the focused light beam toward the combiner 840 so as to form a generally rectangular illuminated region. The combiner 840 forms a virtual image based on the received light beam. As a result, the operator can view a video together with the outside world through the combiner 840.

The light source 810 is a device that renders a video. The light source 810 is configured to emit display light toward the transparent screen 820. For example, as a rendering method, a digital light processing (DLP) method and a method using a laser projector are known. The light source 810 may have a laser projector, and a MEME mirror that performs scanning using a light beam emitted from the laser projector. An example of the laser projector is an RGB laser projector.

The transparent screen 820 has a microlens array on a light-receiving surface. The transparent screen 820 has the function of spreading an incident beam. The field lens 830 is arranged between the transparent screen 820 and the combiner 840, and in the vicinity of the transparent screen 820. The field lens 830 includes, for example, a convex lens, and changes the travel direction of a light beam emitted from the transparent screen 820. By using the field lens 830, the efficiency of use of light can be further improved. It should be noted that the field lens 830 is not essential.

The combiner 840 typically includes, for example, a one-way mirror, and may include a hologram element or the like. The combiner 840 reflects a diverging light beam from the transparent screen 820 to form a virtual image of light. The combiner 840 has the function of enlarging a video formed on the transparent screen 820 and displaying the video at a distance, and overlaying the video on the outside world. As a result, the operator can view a video together with the outside world through the combiner 840. In other words, the operator can view a video displayed on the screen together with the outside world. The size of the virtual image or a position at which the virtual image is formed can be changed, depending on the curvature of the combiner 840. In the HUD unit 800, the combiner 840 serves as a screen of the video display system.

An example of the controller 850 is a processor. The controller 850 serves as a controller of the video display system.

Thus, the technique according to the present disclosure is also applicable to displaying of a video by the HUD unit.

A non-limiting example of a method for displaying a superimposed video according to a second implementation example will be described with reference to FIGS. 22 to 28.

FIG. 22 is a diagram schematically illustrating an example of a superimposed video in which a work trace after ground work in the travel direction are superimposed on a video. FIG. 22 illustrates a situation in which an implement 300 performs hilling work in a field 70. In the second implementation example, the controller displays, on the screen S, a superimposed video in which an image showing a work trace after ground work in the travel direction that is predicted when the work vehicle 100 to which the implement 300 is connected is traveling is superimposed on a video. As a result, in the video displayed on the screen S, an indication showing a work trace after ground work in the travel direction of the work vehicle 100 can be viewed. In the illustrated example, the shape of an outer edge of a hill indicating an imaginary work trace is represented by a line (dotted line) 65. By displaying an imaginary work trace in a video showing a front area, an operator who operates a remote operation device can recognize, before actual work, a work trace to be achieved by the implement 300 as if the work vehicle 100 were viewed from behind, for example. For example, if a predicted work trace as it is after several seconds is virtually displayed on the screen S, the operator can easily recognize a future state such as a work trace after ground work from the superimposed video. This can contribute to an improvement in the operability of remote operation.

The work trace after ground work displayed on the screen S includes a worked state imitating work to be performed by the implement 300. For example, in the case of hilling, the work trace is represented by a pattern or image imitating a state in which hilling has been done. In the case of tillage, the work trace is represented by a pattern or image imitating a state in which tillage has been done. In the case of transplantation, the work trace is represented by a pattern or image imitating a state in which transplantation has been done.

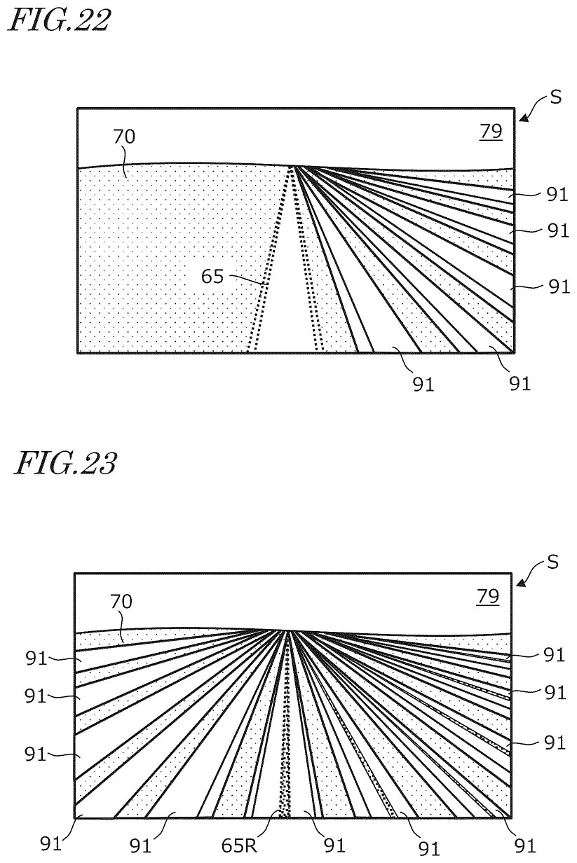

FIG. 23 is a diagram schematically illustrating another example of a superimposed video in which a work traces after ground work in the travel direction are superimposed on a video. FIG. 23 illustrates a situation in which the implement 300 plants seedlings along a hill 91. In the illustrated example, an imaginary crop row 65R is formed as a work trace after ground work on the hill 91 in the travel direction of the work vehicle 100. In other words, the controller generates a superimposed video in which the imaginary crop row 65R formed on the hill 91 is superimposed on a video.

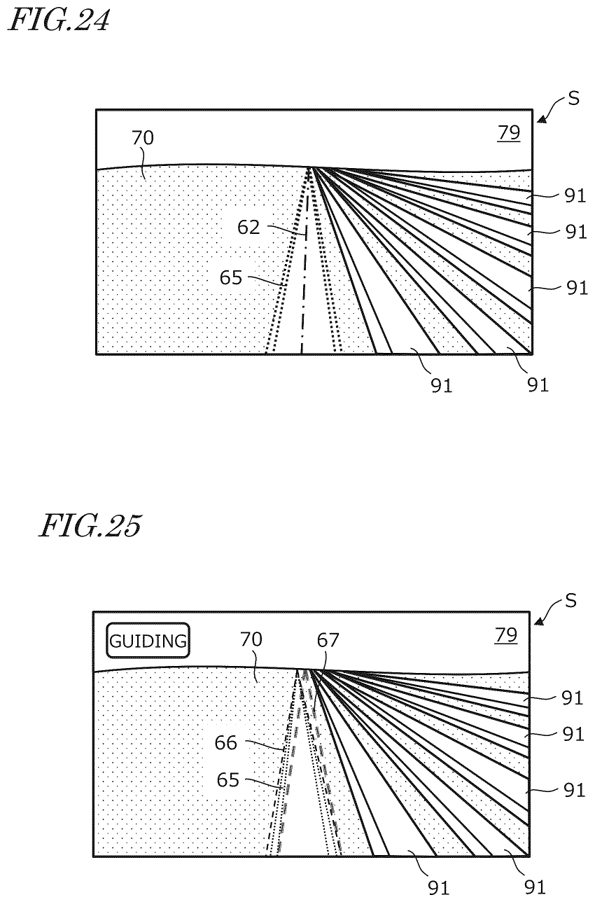

FIG. 24 is a diagram schematically illustrating a superimposed video in which a work trace after ground work and a target line 62 are superimposed on a video. As in the first implementation example, the controller may display, on the screen S, a superimposed video in which a target line 62 along a target path is further superimposed on a video. In the video of this illustrated example, the target line 62 is displayed on a hill indicating a work trace 65.

As in the first implementation example, the controller of the second implementation example predicts a work trace based on implement information relating to the implement 300, and pose information relating to the current pose of the work vehicle 100. For example, the controller predicts a path for the implement 300 including a predicted path for at least one of both end portions of the implement 300. The implement information may include information about the size of an implement, and information about the type of the implement. As described in the first implementation example, the controller predicts a path for the implement 300 based on information about the size of the implement 300 and the pose information when the work vehicle 100 is traveling. The controller may display, on the screen S, a superimposed video in which a predicted path for the implement 300 is further superimposed on a video.

The controller further predicts a work trace based on information about the predicted path for the implement 300 and the type of the implement 300. For example, when the implement 300 performs ground work that is tillage, information about the type of the implement included in the implement information includes information about a tillage depth, tillage width, and the like. In the example of FIG. 22, the implement 300 is a rotary machine for hilling, and the controller may, for example, perform real-time rendering based information on work about hilling, information about tillage depth and tillage width, and information about a predicted path for the implement 300 (coordinate points in the geographic coordinate system), to render a three-dimensional, imaginary hill image showing a work trace after hilling work. In addition, in the example of FIG. 23, the implement 300 is a vegetable transplanter, and the controller may, for example, perform real-time rendering based on crop plating work information including the type of a seedling, and information about a predicted path for the implement 300, to render a three-dimensional, imaginary crop row image showing a work trace after crop planting work. The controller may determine color information, texture, and the like required for displaying an image from the type of ground work, the type of a seedling, or the like.

The data required for rendering a pattern or image imitating a state of a work trace may, for example, be previously stored as a database in association with the type of work in the storage device 650 of the management device 600. For example, the controller determines the type of work with reference to information about the type of an implement and the width information of the implement. The controller reads out, from the database, data required for imitating a state of a work trace associated with the determined work type. The controller can further reference information about a tillage depth, tillage width, and the like, and based on the read data, render a pattern or image imitating a state of a work trace on the screen S.

The controller may display, on the screen S, a superimposed video in which a guidance line for work is further superimposed on a video. The guidance line may be set based on a target line. In this example, a path for the implement 300 is displayed by a work prediction line. The controller may display, on the screen S, a superimposed video including a guidance indication that guides the user, indicating that the work prediction line should coincide with the guidance line.

FIG. 25 is a diagram schematically illustrating an example of a superimposed video including a guidance indication that guides the user, indicating that the work prediction line should coincide with the guidance line. In FIG. 25, a work trace 65, a work prediction line 66, and a guidance line 67 are represented by a dotted line, a dashed line, and a thick dashed line, respectively. The automatic traveling mode of the work vehicle 100 includes a guidance mode in which the user is guided and prompted to cause the work prediction line to coincide with the guidance line, for example. FIG. 25 illustrates a situation in which the work vehicle 100 is automatically traveling in the guidance mode.

The controller may, for example, estimate the amount of a deviation of the work prediction line 66 from the guidance line 67 in a manner similar to that described with reference to FIG. 16. If the deviation amount is less than a threshold, the work prediction line 66 coincides with the guidance line 67. If the deviation amount is not less than the threshold, the work prediction line 66 does not coincide with the guidance line 67. During the time when the work prediction line 66 coincides with the guidance line 67, the controller may, for example, highlight the line indication by increasing the thickness of the work prediction line 66, or changing the color of the work prediction line 66. During the time when the work prediction line 66 does not coincide with the guidance line 67, the controller may, for example, cause the work prediction line 66 to flicker. By thus highlighting the work prediction line 66, depending on the situation, the operator can be guided.

FIG. 26 is a diagram schematically illustrating an example of a superimposed video including a warning indication warning that the work prediction line 66 does not coincide with the guidance line 67. During the time when the work prediction line 66 does not coincide with the guidance line 67, the controller may display, on the screen S, a superimposed video including a warning indication 83 warning that the work prediction line does not coincide with the guidance line. Alternatively, during the time when the work prediction line 66 does not coincide with the guidance line 67, the buzzer 220 of the work vehicle 100 may, for example, serve as a warning indicator warning that the work prediction line 66 does not coincide with the guidance line 67. Examples of the warning indicator are not limited to buzzers, and may be an optical device such as a light-emitting diode or a vibration device such as a vibrator.

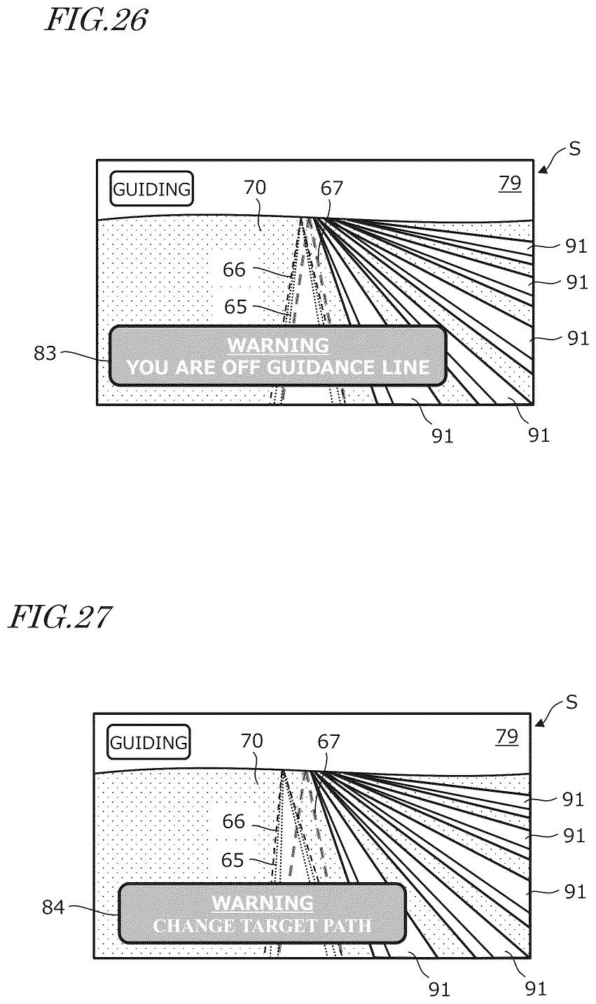

FIG. 27 is a diagram schematically illustrating an example of a superimposed video including a guidance indication that prompts the user to change a target path. If the deviation amount is not less than the threshold, i.e., the work prediction line 66 does not coincide with the guidance line 67, the controller may display, on the screen S, a superimposed video including a guidance indication 84 that prompts the user to change a target path along which the work vehicle 100 is to automatically travel.

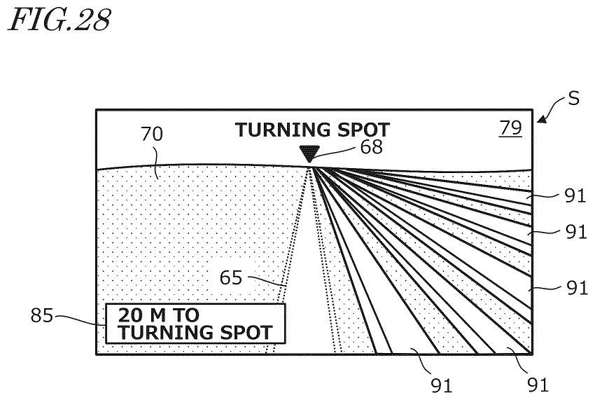

FIG. 28 is a diagram schematically illustrating an example of a superimposed video including an indication of a turning site located in the travel direction of the work vehicle 100. The controller may predict a spot in the travel direction of the work vehicle 100 where the implement 300 is to be started, stopped, or raised or lowered, based on data of time-series images, and display, on the screen S, a superimposed video including an indication of that site. The superimposed video of FIG. 28 includes a turning site indication 68. For example, in the vicinity of a turning site, there is generally a ridge on the opposite side of a headland of a field from a planted area. The controller can, for example, detect a ridge from time-series images by an object detection technique employing machine learning or deep learning. The controller displays the indication 68 at the position of an object specified in an image.

As illustrated in FIG. 28, the controller may display, on the screen S, a superimposed video including an indication 85 of distance information indicating a distance between the current position of the work vehicle 100 and a turning site. The controller may determine a distance to a turning site by performing image analysis on time-series images, or based on sensing data output from a sensor. The superimposed video is not limited to turning sites, and may include an indication of any site where the implement 300 is to be started, stopped, or raised or lowered.

The configurations and operations of the above example embodiments are merely illustrative. The present disclosure is not limited to the above example embodiments. For example, the above various example embodiments may be combined, as appropriate, to provide other example embodiments.

Although in the above example embodiments an agricultural machine performs automated driving, an agricultural machine may not have the automated driving function. The techniques according to the present disclosure are widely applicable to agricultural machines that can be remotely operated.

The systems or video display systems that control automatic traveling and/or remotely-operated traveling according to the above example embodiments can be subsequently added to an agricultural machine that does not have such functions, as an add-on. Such systems may be manufactured and sold separately from agricultural machines. A computer program or programs for use in such a system may also be manufactured and sold separately from agricultural machines. The computer program or programs may, for example, be stored and provided in a non-transitory computer-readable storage medium or media. The computer program or programs may also be downloaded and provided through telecommunication lines (e.g., the Internet).

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A video display system comprising:
a camera attached to a work vehicle to which an implement is connected and configured to generate data of time-series images by performing imaging in a travel direction of the work vehicle;
a screen; and
a controller configured or programmed to display, on the screen, a video based on the data of the time-series images; wherein
the controller is configured or programmed to, when the implement is connected to the work vehicle on an opposite side of the work vehicle from the travel direction, display on the screen, a superimposed video in which a path for the implement is superimposed on the video.

2. The video display system according to claim 1, wherein
the implement is connected to a rear portion of the work vehicle;
the video shows an area in front of the work vehicle;
the controller is configured or programmed to display the video on the screen; and
the controller is configured or programmed to display, on the screen, the superimposed video in which the path for the implement is superimposed on the video.

3. The video display system according to claim 1, wherein the controller is configured or programmed to predict the path for the implement based on implement information relating to the implement and pose information relating to a current pose of the work vehicle.

4. The video display system according to claim 2, wherein the controller is configured or programmed to:
predict a path for a wheel of the work vehicle based on the pose information when the work vehicle is traveling; and
display, on the screen, the superimposed video in which the path for the wheel of the work vehicle is further superimposed on the video.

5. The video display system according to claim 3, wherein:
the work vehicle is capable of automatically traveling; and the controller is configured or programmed to display, on the screen, the superimposed video in which a target line along a target path to be set to cause the work vehicle to automatically travel is further superimposed on the video.

6. The video display system according to claim 3, wherein the controller is configured or programmed to:
estimate a deviation amount of a predicted path for the implement from a reference path predicted from past tracks of the implement, based on the predicted path and the reference path; and
display different indications on the screen, depending on whether or not the deviation amount is less than a threshold.

7. The video display system according to claim 6, wherein the controller is configured or programmed to, when the deviation amount is not less than the threshold, display, on the screen, the superimposed video including a warning indication warning that the predicted path for the implement deviates from the past tracks.

8. The video display system according to claim 3, wherein the controller is configured or programmed to predict the path for the implement including a predicted path for at least one of both end portions of the implement located in a width direction of the implement.

9. The video display system according to claim 3, wherein the controller is configured or programmed to obtain the implement information including a size of the implement by communicating with the implement.

10. The video display system according to claim 3, wherein the controller is configured or programmed to obtain the implement information including a size of the implement input by a user through an input interface.

11. The video display system according to claim 9, further comprising:
a sensor to obtain sensing data indicating a distribution of objects on the ground around the work vehicle;
wherein
the controller is configured or programmed to:
estimate a size of an object existing on the ground in the travel direction of the work vehicle based on the sensing data output from the sensor; and
display, on the screen, the superimposed video including a warning indication warning that the implement is likely to hit the object on the ground, depending on a result of comparison between the size of the implement and the size of the object on the ground.

12. The video display system according to claim 1, further comprising:
a light source to be controlled by the controller; and
an optical system to receive light emitted from the light source and form a virtual image in front of the screen.

13. An agricultural machine comprising:
a work vehicle;
an implement; and
the video display system according to claim 1.
